(19) United States
(12) Patent Application Publication
(10) Pub. No.: US 2021/0358062 A1
(43) Pub. Date: Nov. 18, 2021

(54) SYSTEM AND METHOD FOR ON-DEMAND OWNERSHIP MANAGEMENT

(71) Applicant: KEY LIVING CORPORATION, Toronto (CA)

(72) Inventors: Robert Donald RICHARDS, Toronto (CA); Yash MODY, Toronto (CA); Derek Jack MANUGE, Toronto (CA)

(21) Appl. No.: 17/351,790

(22) Filed: Jun. 18, 2021

Related U.S. Application Data
(63) Continuation-in-part of application No. PCT/IB2020/062242, filed on Dec. 18, 2020.
(60) Provisional application No. 62/994,506, filed on Mar. 25, 2020.
(60) Provisional application No. 62/952,237, filed on Dec. 21, 2019.

(51) Int. Cl. G06Q 50/16; G06Q 30/06

(52) U.S. Cl. CPC G06Q 50/167; G06Q 30/06

(57) ABSTRACT

A system and method for on-demand ownership management is provided. In particular, a computing device receives an indication of: a first fungible amount of a first type; and a particular property. The computing device identifies an equity indicator associated with the particular property. The computing device converts the first fungible amount of the first type into a second fungible amount of a second type, different from the first type, the second type associated with property value. The computing device causes the equity indicator to change by an amount related to the second fungible amount of the second type. The computing device changes a periodic payment request for the particular property, providable to a communication device associated with the indicator, relative to a previous payment request, to indicate the change to the equity indicator and/or generally causes an action associated with an electronic device.

### CROSS-REFERENCE TO RELATED APPLICATIONS

The present specification is a bypass continuation-in-part of PCT Application No. PCT/IB2020/062242, filed Dec. 18, 2020, which claims priority from U.S. Provisional Patent Application No. 62/952,237, filed Dec. 21, 2019, and further claims priority from U.S. Provisional Patent Application No. 62/994,506, filed Mar. 25, 2020, the entire contents of each being incorporated by reference herein.

### FIELD

The present description relates to computer-implemented asset management, and in particular to a distributed on-demand property ownership management system (OMS) and a contractual obligation engine (COE) for facilitating consumer financial and ownership transactions.

### BACKGROUND

Property ownership has become increasingly unattainable for many people living in fast-growing cities around the world. Real estate is expensive, requiring a substantial down payment and long-term debt commitment from consumers. High costs, in terms of real estate agent commissions and change of title costs are typically associated with buying and selling traditional real estate.

To mitigate this situation and allow for consumers to enter the housing market more easily, many different methods have been attempted. Rent-to-own and lease-to-own are alternatives for property buyers who may have difficulty qualifying for a mortgage or may not have the requisite down payment saved

A rent-to-own property is a property that can be bought through a rent-to-own agreement. As part of the contract, the seller agrees to hold a designated amount of money of each rent payment to go toward the buyer's equity in the property when they purchase it in the future. Instead of a typical down payment of around 20% of the property's purchase price and paid to the mortgage lender, the buyer pays a one-time option-to-buy fee, which is typically 3% to 5% of the purchase price and paid to the seller. There are many issues with this model, as a consumer may pay upfront fees and higher monthly payments than if they were renting. The option-to-buy fee is not refundable if the buyer opts not to buy the property. In some situations, if a consumer misses a payment, the whole deal is off. In other cases, a consumer may discover that at the end they are locked into paying more than the property is actually worth, or that they can't qualify for a mortgage to finish paying off the property. In a rent-to-own arrangement, payments and fees are generally fixed, calculated in advance and the payment terms are inflexible and static.

Lease-to-own is similar to rent-to-own. During the term of the option, the buyer agrees to lease the property from the seller for a predetermined rental amount. The option money generally does not apply toward the down payment, but a portion of the monthly lease payment goes toward the purchase price. The key difference, however, is that rent-to-own offers an option to buy, while a lease-to-own purchase may obligate the tenant to buy. Lease-to-own payments and fees are generally also fixed and calculated in advance. These payment terms are inflexible and static. Furthermore, the buyer is obligated to make the final lump sum payment to buy the property without any alternate option.

Co-living is a form of communal living in which a plurality of residents share a multi-bedroom or multi-apartment property with private areas and shared common areas. Co-living is popular in major cities as a means of affordable living for students, nomad workers, or individuals relocating and wanting to experience the new city with built-in interaction with strangers. Co-living can be attractive to consumers due to affordability, flexibility, included amenities, and a sense of community. The consumers in the co-living agreement do not own the real estate property but merely rent it on a collective basis with each individual having the flexibility to move out as and when needed. Co-living currently provides no means for the consumer to establish an equity investment in the real estate owned by the Co-living companies. In a co-living arrangement monthly payments may be flexible or fixed, and can be calculated in advance but also on a month-to-month basis. Although the term of stay is flexible, this arrangement does not offer any opportunity for ownership or financial growth opportunity.

A co-op, short for “cooperative,” is a housing arrangement where a plurality of participants own shares of a corporation that in turn owns all of the property in the cooperative. As a part-owner of the company these owners may have the right to live on the premises. Typically, participants in a co-op get locked into a single property and are usually obligated to take on certain property management duties. Co-ops can often be governed by stricter rules than are condominiums, with restrictions on subletting, on admission criteria, or on parents purchasing for their children. Co-op boards wield an inordinate amount of control and influence over members' lives. There may also be stricter rules for financing as a co-op association may accept very little loan financing or none at all. Buyers are subject to intense financial scrutiny when applying to buy into a co-op, making it more difficult to buy and even harder to sell co-op shares, since a seller may invest time and resources to find a buyer, only to have the co-op board reject the buyer. Thus, the co-op model has many shortcomings that restrict it from mass adoption. In a co-op arrangement, monthly payments are generally fixed and calculated in advance, not changing from month-to-month or providing any flexibility. These payment terms do not reflect the changes in the market nor offer any opportunity to amend the payment structure.

A timeshare is a mechanism where a plurality of buyers shares the occupancy of a property, usually a vacation property located in a resort. Each buyer usually purchases a certain period of time in a particular unit. The minimum purchase is a one-week ownership, and the high-season weeks demand higher prices. Units may be sold as a partial ownership deed, but more often as shares in a holding company with a lease provision or a “right to use”, in which case the purchaser holds no real claim to ownership of the property. With right-to-use contracts, a purchaser has the right to use the property in accordance with the contract, but at some specified point in time the contract ends and all rights revert to the property owner. A timeshare can be suitable for vacations but is not a suitable ownership mechanism for a principal residence. In addition to issues related to rights, timeshares become prohibitively expensive to own for more than a few weeks a year. In a timeshare payments are primarily annual maintenance fees which are fixed and additional costs may apply on a pay-as-use basis. This arrangement does not offer any opportunity for ownership or financial growth.

A Real Estate Investment Trust (REIT) is a company that owns, and in most cases operates, income-producing real estate. REITs can be publicly traded on major exchanges, publicly registered but non-listed, or private. Depending on their types, individuals or other companies can buy shares in a REIT. Buying shares in a REIT does not include any occupancy rights. An investor may choose to rent in a REIT-controlled building as an independent decision to the investment in shares, but there is no relation between the two and no path to get on the real estate owner-occupancy ladder. In REIT monthly payments are generally fixed and calculated in advance. The payments or payment terms do not change month-to-month, thus not offering any flexibility. These payments do not reflect the changes in the market and do not offer any opportunity to make changes to the payment structure.

In a fractional ownership arrangement, a number of participants get together to buy fractions of a real estate property. In most cases to date, fractional purchases provide pro-rata share of the real estate but no occupancy rights (passive investment in residential towers, hotels, commercial properties, etc.). In single family or multi-family residential markets, fractional ownership can come with the right to use the property in proportion to the fraction of ownership. This is an emerging model for the sharing of three- or four-bedroom properties, but not well developed for multi-residential buildings. Rights and obligations are sometimes opaque, specifically around share of ongoing expenses and capital budgets, resale rights and the like. Fractional ownership may be associated with crowdfunding programs or security token offerings, both methods of finance being nascent. Fractional ownership suffers from all the issues typically associated with traditional real estate, with new issues related to ongoing capitalization and governance.

The prior art ownership models discussed above require for their implementation, legal and financial transactions between various entities, such as consumers, financial institutions, local property management and third-party service providers (e.g., cleaning services, moving services, child-care services, pet care services, etc.). However, according to prior art ownership models such transactions between entities are disparate and asynchronous. Although, computer systems may be implemented within each of these entities, such as consumer devices transacting with financial institution systems and local property management, and with local property management and/or third-party services, a technological problem exists in integrating and automating such transactions to provide an ownership mechanism for consumers to easily occupy a property or move from one property to another without incurring buy/sell costs, with proper governance, while maintaining and growing a related equity investment. For example, prior art ownership models do not provide any method for communicating to an owner-resident their payment obligations that are dynamic and changing over time.

The description above is presented as a general overview of related art in this field and should not be construed as an admission that any of the information it contains constitutes prior art against the present patent application.

### SUMMARY

According to an aspect of this disclosure, a network-based OMS is provided for integrating and automating financial and legal transactions between disparate entities, such as consumers, financial institutions, local property management and third-party service providers (e.g., cleaning services, moving services, child care services, pet care services, etc.), so as to establish an ownership mechanism for consumers to easily occupy a property or move from one property to another without incurring buy/sell costs, with proper governance, while maintaining and growing a related equity investment. The established ownership mechanism differs from traditional real estate ownership and is characterized by the following features: title-less ownership with occupancy rights, wholly electronic ownership management, low minimum investment, no mortgage or other form of personal debt, no real estate broker commissions, or other expenses to pay when buying or selling, no lawyers or inspectors or stagers to deal with or pay, and the ability to easily change occupancy from one property to another with an equity investment that is fully portable.

The OMS as set forth herein includes one or more computer servers configured to coordinate transactions between such disparate entities, including at least one consumer and one or more local property management servers (LPMS). An example method may be implemented by the OMS for creating and maintaining a consumer profile, establishing bidirectional communication between a requesting consumer and the OMS and obtaining, for example via a graphical user interface operable on a device of the consumer, preferences concerning property ownership at a desired location, property type, size and living arrangements, and a request from the consumer for property ownership. The OMS can then search for properties available via the LPMS that match the consumer preferences, and upon consumer selection of a desired property enable a financial transaction and an ownership and occupancy change transaction and record that in the OMS. The OMS can then provide a confirmation to the consumer regarding completion of the financial transaction and ownership rights and occupancy rights on a part-ownership basis along with a date and time for the requesting consumer to move into the property.

The OMS also preferably includes a user interface configured to provide information to local personnel associated with a local property through the LPMS at the location of the consumer selected property, regarding change in ownership along with date and time of start of occupancy and date and time of consumer move into the property if the two are different.

The OMS and/or LPMS may preferably be in communication with one or more third party service providers such as a moving company, cleaning services company, child care company, pet care company, etc., and configured to display these third party service providers to the consumer preferably along with their charges, and engage desired third party service providers upon receiving a request from the consumer, including providing notifications detailing date and time and other preferences to the consumer, and conducting a financial transaction by deducting funds from the consumer's account at a financial institution, transferring funds to the selected third party's account after the completion of the service and preferably retaining a portion of the funds for facilitating and supervising the engagements.

In accordance with another aspect of this disclosure, the OMS preferably includes a contractual obligation engine (COE) for creating a computer-implemented synthetic form of co-ownership with occupancy rights, and for providing automated communication to an owner-resident of payment obligations that are dynamic and changing over time (e.g., automated reductions in monthly payments with increased equity based on value of the property). In an aspect, the COE calculates the value of a property on a regular periodic basis, establishing the synthetic co-ownership interest for the owner-resident, attaching rights and obligations to that interest, porting the interest seamlessly between properties, adjusting the interest up or down with minimal steps on a regular periodic basis, calculating financial obligations associated with residency on a regular periodic basis with a proprietary formula for residency payment as a function of the co-ownership interest and the calculated value of the property, and automating legal and financial transactions associated with maintaining residency payments and in response increasing or decreasing co-ownership interest. The network-based system integrates several platform services to provide automation and speed of service.

The secure administration of the COE requires the use of computer technology and network connections that are not available through existing ownership models, including identity verification, access to financial accounts and instruments, and digital execution of contracts facilitated by a key system to securely validate and assure the owner-resident has continual access to the property via the OMS.

The COE as set forth herein provides an owner-resident access to equity growth and occupancy rights available through traditional title ownership without traditional barriers to access for title and with a highly simplified process that removes time, cost, and intermediaries.

In an embodiment, the COE computes a suite-based contractual obligation and preferably saves it to a database in the OMS.

In another embodiment, the COE computes an EVA (equity value adjustment), which is the difference between the suite Market contractual obligation and the suite-based contractual obligation and preferably saves it in a database in the OMS.

In another embodiment, the COE aggregates a total suite-based equity value adjustment, which is the sum of all suite-based equity value adjustments, and preferably saves this value in a database in the OMS.

In another embodiment, the COE aggregates a total portfolio equity which is the sum of all suite's owner's equity and the total investors' equity and stores it preferably in a database in the OMS.

In another embodiment, the COE computes the equalization of profit for all stakeholders: i.e. owner-residents and non-resident investors, for example to provide the same financial return on their investment in the ODRE, and stores it preferably in a database in the OMS.

In another embodiment, the COE computes a portfolio-based equity value adjustment and stores it preferably in a database in the OMS.

In another embodiment, the COE computes the contractual obligation adjustment factor, which is the difference between suite-based equity value adjustment and portfolio-based equity value adjustment and preferably saves it in a database in the OMS that stores related information.

In another embodiment, the COE computes the portfolio-based contractual obligation, which is the sum of suite-based contractual obligation and contractual obligation adjustment factor and preferably saves it to a database in the OMS that stores related information.

In another embodiment, the COE may use a linear relationship graph for computing its different values. In other embodiments of the invention the contractual obligation engine may use parabolic, quadratic, hyperbolic logarithmic or other kind of relationship graphs for computing various methods of calculating our results.

In another embodiment, contractual obligation may also be referred to with various other terms e.g. monthly payment, buydown, rent reduction or the like.

In another embodiment, the “adjustment factor” may be conveyed to the owner-resident in the form of cash, gift card, loyalty points, reduction in fees/expenses/costs, dividends, or other forms in one or different combinations of the aforementioned.

In another embodiment, the COE sources of input variables may be composed of one or more combinations of local, regional and/or global variables when computing the various factors.

An aspect of the disclosure provides a property ownership management system, comprising: at least one local property management server; a first interface for communicating with at least one consumer via a consumer device; a second interface for communicating with at least one financial institution using secure communications; a third interface for communicating with the at least one local property management server; at least one central server configured to receive via the first interface a consumer request to purchase ownership of a property characterized by consumer preferences selected by filtering property criteria including one or more of a desired location, move in date, alternate move in date, property type, size and living arrangements, search an availability database for any available property according to the filtered property criteria for matching the selected consumer preferences, transmit via the first interface at least one property proposal to the consumer device, wherein the property proposal matches at least one of the filtered property criteria, generate via the consumer device a reservation request to reserve the at least one property proposal, including financial data in support of the reservation request, receive the reservation request via the first interface, transmit via the second interface a financial transaction request and the financial data to the at least one financial institution to secure consumer funds, receive via the second interface consumer funds from the at least one financial institution to complete the financial transaction, create a contract for recording occupancy rights, equity in the reserved property and the financial transaction, update the availability database to remove availability of the reserved property, transmit to the consumer via the first interface confirmation of the contract and notification of a date of occupancy start, and transmit to the at least one local property management server via the third interface notification regarding change of ownership of the reserved property and move in date.

Another aspect of the disclosure provides a contractual obligation engine, comprising: a calculator module; a suite value module for processing property value; a database pointing to an equity table for maintaining one or more of consumer equity position values and payment obligations; and a payment gateway, wherein the calculator module is configured to receive a monthly contractual payment obligation value for a property from the database, receive a base payment value from the database representing costs associated with operating the property, receive a payment benefit coefficient from the database representing consumer percent equity in the value of the property, calculate an additional payment value by multiplying the difference between the monthly contractual payment obligation value and the base payment value by the payment benefit coefficient, and generate a suite-based contractual obligation value payable by the consumer, by summing the base payment value and additional payment value, such that the suite-based contractual obligation value represents a discount of the monthly contractual payment obligation value by a suite-based equity value adjustment related to the payment benefit coefficient.

Another aspect of the present specification provides a method comprising: receiving, at a computing device, an indication of: a first fungible amount of a first type; and a particular property; identifying, via the computing device, an equity indicator associated with the particular property; converting, at the computing device, the first fungible amount of the first type into a second fungible amount of a second type, different from the first type, the second type associated with property value; causing, via the computing device, the equity indicator to change by an amount related to the second fungible amount of the second type; and changing, via the computing device, a periodic payment request for the particular property, providable to a communication device associated with the indicator, relative to a previous payment request, to indicate the change to the equity indicator.

Another aspect of the present specification provides a device comprising: a communication interface; and a controller configured to: receive, via the communication interface, an indication of: a first fungible amount of a first type; and a particular property; identify an equity indicator associated with the particular property; convert the first fungible amount of the first type into a second fungible amount of a second type, different from the first type, the second type associated with property value; cause the equity indicator to change by an amount related to the second fungible amount of the second type; and change a periodic payment request for the particular property, providable to a communication device associated with the indicator, relative to a previous payment request, to indicate the change to the equity indicator.

Another aspect of the present specification provides a method comprising: receiving, at a computing device, an indication of: a first particular property; a second particular property, and a first fungible amount of a first type associated with the first particular property; identifying, via the computing device, a first equity indicator associated with the first particular property and a second equity indicator associated with the second particular property; converting, at the computing device, the first fungible amount of the first type into a second fungible amount of a second type, different from the first type, the second type associated with property value; causing, via the computing device, the first equity indicator to reduce by a first amount associated with the second fungible amount and the second equity indicator to increase by a second amount associated with the second fungible amount; and changing, via the computing device, respective periodic payment requests for the first particular property and the second particular property, providable to respective communication devices associated with the first particular property and the second particular property, relative to respective previous payment requests, to indicate changes to the first equity indicator and the second equity indicator.

Another aspect of the present specification provides a device comprising: a communication interface; and a controller configured to: receive, via the communication interface, an indication of: a first particular property; a second particular property, and a first fungible amount of a first type associated with the first particular property; identify a first equity indicator associated with the first particular property and a second equity indicator associated with the second particular property; convert the first fungible amount of the first type into a second fungible amount of a second type, different from the first type, the second type associated with property value; cause the first equity indicator to reduce by a first amount associated with the second fungible amount and the second equity indicator to increase by a second amount associated with the second fungible amount; and change respective periodic payment requests for the first particular property and the second particular property, providable to respective communication devices associated with the first particular property and the second particular property, relative to respective previous payment requests, to indicate changes to the first equity indicator and the second equity indicator.

Another aspect of the present specification provides a method comprising: receiving, at a computing device, an indication of a particular property; identifying, via the computing device, an equity indicator associated with the particular property; determining, via the computing device, a first fungible amount of a first type associated with an action; converting, at the computing device, the first fungible amount of the first type into a second fungible amount of a second type, different from the first type, the second type associated with property value; causing, via the computing device, the equity indicator to decrease by an amount related to the second fungible amount of the second type; causing, via the computing device, the action; and changing, via the computing device, a periodic payment request for the particular property, providable to a communication device associated with the indicator, relative to a previous payment request, to indicate the change to the equity indicator.

Another aspect of the present specification provides a device comprising: a communication interface; and a controller configured to: receive, via the communication interface, an indication of a particular property; identify an equity indicator associated with the particular property; determine a first fungible amount of a first type associated with an action; convert the first fungible amount of the first type into a second fungible amount of a second type, different from the first type, the second type associated with property value; cause the equity indicator to decrease by an amount related to the second fungible amount of the second type; cause, via the communication interface, the action; and change a periodic payment request for the particular property, providable to a communication device associated with the indicator, relative to a previous payment request, to indicate the change to the equity indicator.

The details of one or more variations of the subject matter described herein are set forth in the accompanying drawings and the description below. Other features and advantages of the subject matter described herein will be apparent from the description and drawings.

### DESCRIPTION OF DRAWINGS

For a better understanding of the various examples described herein and to show more clearly how they may be carried into effect, reference will now be made, by way of example only, to the accompanying drawings, where like reference numerals refer to identical or functionally similar elements throughout the separate views, and in which

FIG. 1A is a block diagram of a system for on-demand property ownership, in accordance with an example of the present disclosure.

FIG. 1B is a block diagram of the system of FIG. 1A implemented over a portfolio of properties according to one possible example of the present disclosure.

FIG. 2A is a flowchart showing a method implemented by the system of FIG. 1A for facilitating a consumer financial and ownership transaction, according to an embodiment.

FIG. 2B is a functional diagram of the system of FIG. 1A for onboarding a new consumer according to the method of FIG. 2A.

FIG. 3 is a flowchart showing a method implemented by the system of FIG. 1A for facilitating a consumer financial and ownership transaction, according to an additional embodiment.

FIG. 4 is a flowchart showing a method implemented by the system of FIG. 1A for facilitating a consumer financial and ownership transaction, according to an additional embodiment.

FIG. 5 is a flowchart showing a method implemented by the system of FIG. 1A for facilitating a consumer financial and ownership transaction, according to an additional embodiment.

FIG. 6 is a flowchart showing a method implemented by the system of FIG. 1A for facilitating a consumer financial and ownership transaction, according to an additional embodiment.

FIG. 7 is a block diagram of a contractual obligation engine (COE), according to an embodiment.

FIG. 8 is a flowchart showing a method implemented by the COE of FIG. 7 for calculating a suite-based contractual obligation, according to an embodiment.

FIG. 9 is a flowchart showing a method implemented by the COE of FIG. 7 for calculating a suite-based equity value adjustment.

FIG. 10 is a flowchart showing a method implemented by the COE of FIG. 7 for calculating a total all-suite-based equity adjustment value representing an aggregate payment benefit for all equity owners of a portfolio of properties.

FIG. 11 is a flowchart showing a method implemented by the COE of FIG. 7 for calculating total portfolio equity for the portfolio of properties.

FIG. 12 is a flowchart showing a method implemented by the COE of FIG. 7 for calculating a portfolio-based equity adjustment value.

FIG. 13 is a flowchart showing a method implemented by the COE of FIG. 7 for calculating a contractual obligation adjustment factor.

FIG. 14 is a flowchart showing a method implemented by the COE of FIG. 7 for calculating a portfolio-based contractual obligation value.

FIG. 15 is a graph showing a relationship between portfolio payment reduction and pledged portfolio equity, according to an example.

FIG. 16, which includes FIG. 16A and 16B, is a graph showing a relationship between obligated consumer payments and pledged equity without equity value adjustment (FIG. 16A) and with equity value adjustment (FIG. 16B), according to an example.

FIG. 17 is a system to change periodic payment requests for particular properties relative to previous payment requests, to indicate changes to equity indicators, according to an example.

FIG. 18 is a flowchart showing a method to change periodic payment requests for particular properties relative to previous payment requests, to indicate changes to equity indicators, according to an example.

FIG. 19 shows the system of FIG. 17 implementing aspects of the method of FIG. 18, according to an example.

FIG. 20 shows the system of FIG. 17 implementing other aspects of the method of FIG. 18, according to an example.

FIG. 21 is a system to change a plurality of periodic payment requests for a plurality of particular properties relative to respective previous payment requests, to indicate changes to a plurality of equity indicators, according to an example.

FIG. 22 is a flowchart of a method to change a plurality of periodic payment requests for a plurality of particular properties relative to respective previous payment requests, to indicate changes to a plurality of equity indicators, according to an example.

FIG. 23 shows the system of FIG. 21 implementing aspects of the method of FIG. 22, according to an example.

FIG. 24 is a system to exchange equity value between equity indicators, according to an example.

FIG. 25 is a flowchart of a method to change periodic payment requests for two particular properties, according to an example.

FIG. 26 shows the system of FIG. 24 implementing aspects of the method of FIG. 25, according to an example.

FIG. 27 is a block diagram of a contractual obligation engine (COE) adapted for equity indicator adjustment, according to an embodiment.

FIG. 28 is a flowchart of a method for changing a periodic payment request by reducing an equity indicator in association with causing an action, according to an example.

FIG. 29 shows the system of FIG. 18 implementing aspects of the method of FIG. 28, according to an example.

FIG. 30 shows the system of FIG. 18 implementing further aspects of the method of FIG. 28, according to an example.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth to provide a thorough understanding of the exemplary embodiments described herein. However, it will be understood by those of ordinary skill in the art that the embodiments described herein may be practiced without these specific details. In other instances, well-known methods and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

In this description and in the drawings, ODRE denotes property in the form of on-demand real estate administered by the ownership management system (OMS) set forth herein, and COE denotes a contractual property engine of the OMS. Also, in connection with describing the COE, references to “suite” denotes an ODRE property within a building, such as a high rise or midrise building at a location.

Computer program code for carrying out operations of the present invention may be written in any combination of one or more programming languages, including in object-oriented programming languages such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, TypeScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU or GPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example, and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a standalone computer, a server, a server farm, virtual machines, cloud computing, on the mobile device as a stand-alone software package, partly on the mobile device and partly on a remote computer or remote computing device or entirely on the remote computer or server or computing device. In the latter scenario, the remote computers may be connected to each other or the mobile devices through any type of network, including a local area network (LAN) or a wide area network (WAN), or the connection may be made to the internet through a mobile operator network (e.g., a cellular network); WiFi, Bluetooth, etc.

The servers and processors may be physical or virtual e.g., implemented in a cloud architecture. The processing may be accomplished using a Central Processing Unit (CPU) or a Graphic Processing Unit (GPU).

Modern GPUs are very efficient at manipulating computer graphics and image processing. Their highly parallel structure makes them more efficient than general-purpose Central Processing Units (CPUs) for algorithms that process large blocks of data in parallel.

Architecturally, the CPU is composed of just a few cores with lots of cache memory that can handle a few software threads at a time. In contrast, a GPU is composed of hundreds of cores that can handle thousands of threads simultaneously. The ability of a GPU with 100 plus cores to process thousands of threads can accelerate computation requiring parallel processing. Additionally, a GPU may achieve this acceleration while being more power- and cost-efficient than a CPU.

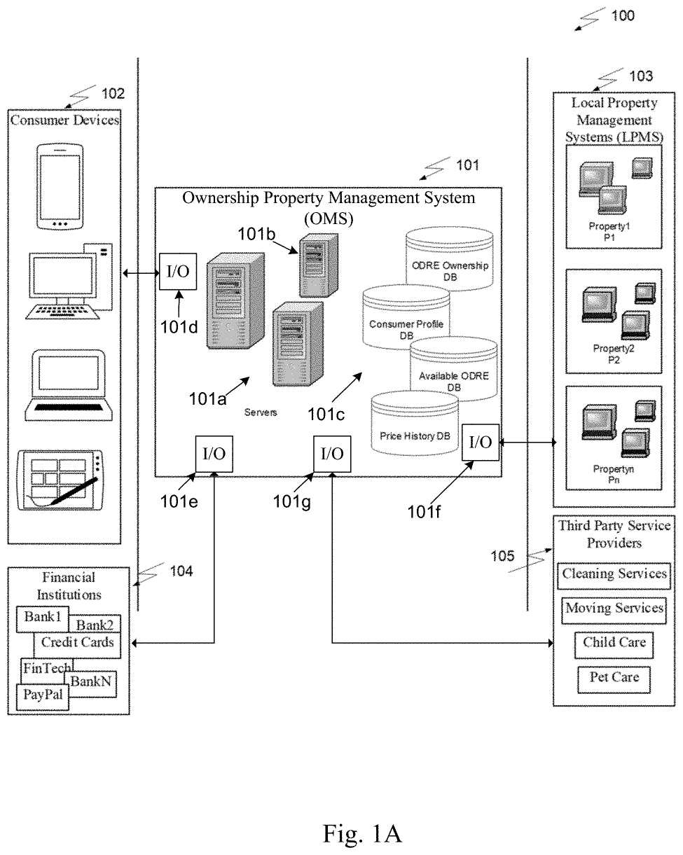

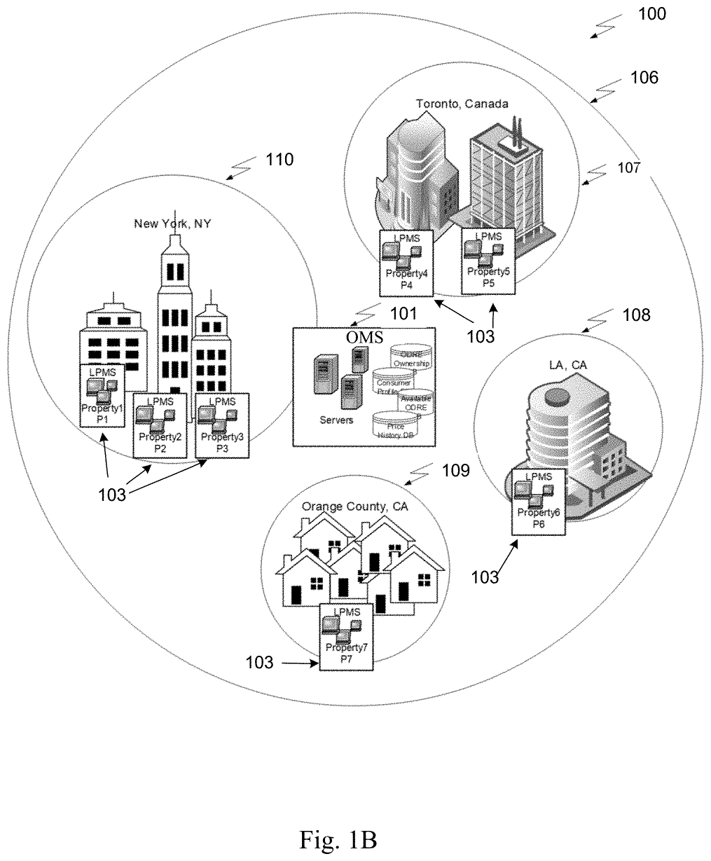

Turning now to FIG. 1, a system 100 for on-demand property ownership is depicted, in accordance with an example embodiment, including a network-based OMS 101, including one or more computer central servers 101a, at least one of which is configured as a contractual obligation engine (COE) 101b, as a and at least one database (DB) 101c, for integrating and automating financial and legal transactions between consumer devices 102 via a first interface 101d, financial institutions 104 (e.g., banks, credit card companies, PayPal and the like) via a second interface 101e, local property management servers (LPMS) 103 via a third interface 101f, and third-party service providers 105 via a fourth interface 101g, so as to establish an ownership mechanism for consumers to easily occupy a property or move from one property to another without incurring buy/sell costs, with proper governance, while maintaining and growing a related equity investment.

Consumer devices 102 may include but are not limited to Smartphones, computers, laptops, desktops, tablet computers, and the like.

Third-party service providers 105 may include cleaning service companies, childcare companies, pet care companies, moving companies, grocery companies, etc.

The OMS 101 may preferably manage one or more real estate properties e.g. condominium suites located in one or more different physical locations depicted by Property1 P1, Property2 P2 and Property3 P3, and or all of which can be a high rise buildings with multiple residential units in each, or a set of midrise residential units, or a collection of townhomes, or a collection of semi-detached or detached single homes, and any combination thereof. The invention is not limited to these property types and this list is exemplary and not limiting.

The OMS 101 may preferably be configured to remotely connect to one or more Local Property Management servers (LPMS) 103. The LPMS 103 may be further configured to manage the various aspects of the real estate properties e.g. access control to the property and associated units, key authorizations, maintenance and care of the real estate building, and to provide information to local personnel associated with a local property through the LPMSs 103 regarding change in ownership along with date and time of start of occupancy and date and time of consumer move as well as provisioning of any consumer selected third party services 105, such as cleaning service companies, childcare companies, pet care companies, moving companies, grocery companies, etc.

OMS 101 includes a first user interface configured to gather property criteria from a consumer device 102, via a first graphical user interface displayable on the device 102. In another embodiment, the first user interface may be a voice activated interface for gathering consumer property criteria. One or more of the central servers 101a may be configured to search available properties in an availability database such as Available ODRE (On-Demand Real Estate) DB 101c that match the consumer criteria at desired location (P1, P2 . . . Pn).

One or more of the servers central 101a periodically poll the multiple LPMSs 103 at respective locations (P1, P2 . . . Pn), to maintain current availability data in the Available ODRE DB 101c. Alternatively the respective LPMSs 103 may be programmed to push updated availability data to the Available ODRE DB 101c in response to a change in local occupancy.

One or more of the central servers 101a may be configured for completing, upon consumer selection of a desired property to occupy, a financial transaction and an ownership change transaction and recording the same in an ODRE Ownership DB 101c, and to provide a confirmation to the consumer regarding completion of the financial and ownership transactions and ownership rights and occupancy rights associated with the property.

The OMS 101 and/or the LPMS 103 may preferably be in communication with one or more third party service providers 105, for example at least one moving company, at least one cleaning services company, at least one child care company, at least one pet care company, at least one grocery company, and to display these third party service providers preferably along with their charges, as well as engage desired third party service providers upon receiving a request from the consumer, and provide notifications detailing date and time and other preferences to the consumer, selected third parties and local management personnel, and to conduct a financial transaction by deducting funds from the consumer account, transferring funds to the selected third party's account after the completion of the service and retain a portion of the funds for facilitating and supervising the engagements.

FIG. 1B is a block diagram of the on-demand property ownership system 100 according to FIG. 1A implemented over a portfolio 106 of properties, according to one possible example of the present disclosure, comprising multiple properties 107, 108, 109 and 110 in different cities, wherein each property may be composed of one or multiple suites, and wherein OMS 101 manages the ownership rights and occupancy rights associated therewith. In the illustrated example, properties 107 in a first city e.g., Toronto, Canada, may be composed of two high-rise buildings with multiple suits/units in each building having a dedicated LPMS associated with property, property 108 in a second city e.g., Los Angeles, Calif. USA, may be composed of one midrise building with multiple suits in the building having its own dedicated LPMS, properties 109 in a third city e.g., Orange County, Calif. USA, may be composed of multiple single-family homes that collectively share a dedicated LPMS, and properties 110 in a fourth city e.g., New York, N.Y. USA, may be composed of multiple high-rise and midrise buildings with multiple suits in each building and having a dedicated LPMS 103. Alternatively, rather than having a dedicated LPMS 103 associated with each property 107, 108, 109 and 110, it is contemplated that a centralized LPMS may collectively service all of the multi-suite buildings in a given city or region.

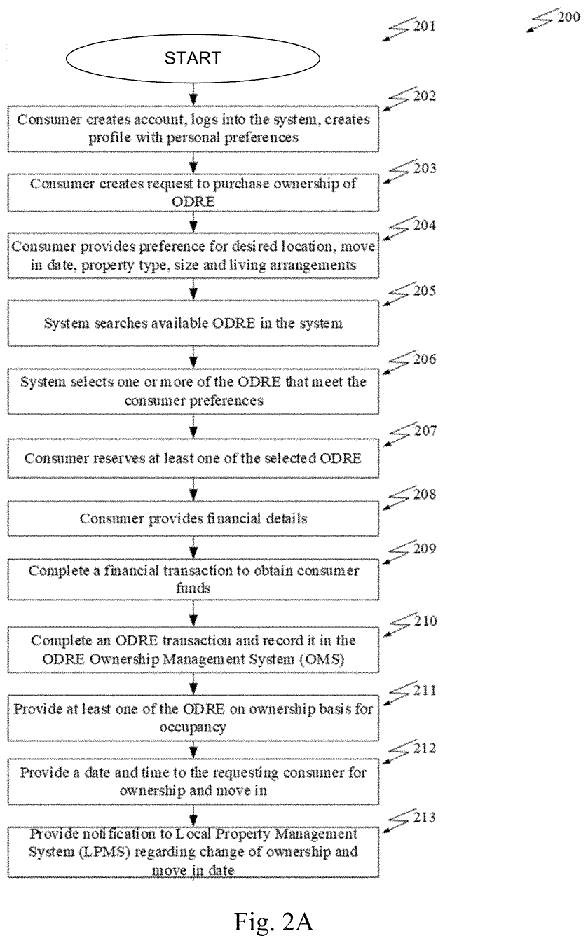

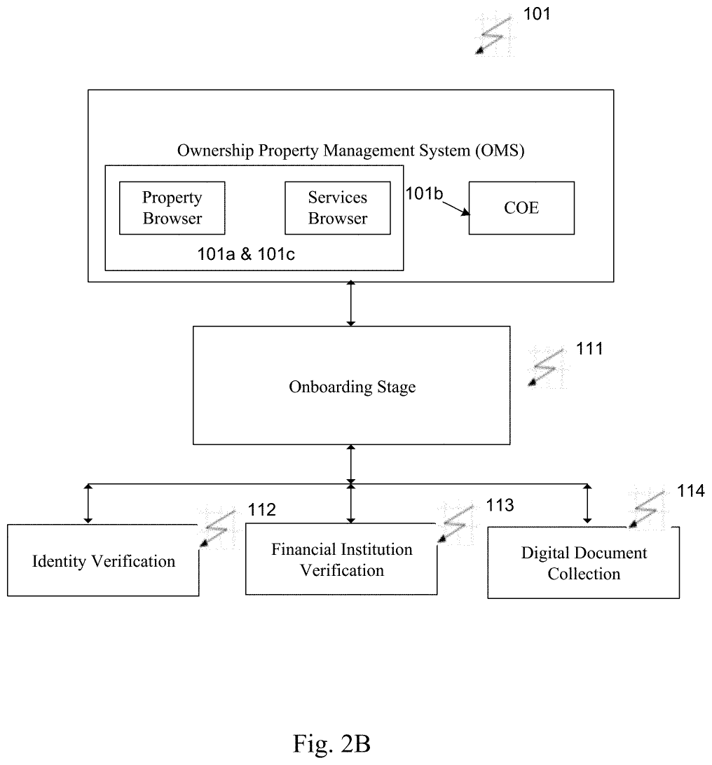

FIG. 2 is a flowchart showing a method 200 implemented by OMS 101 for facilitating a consumer financial and ownership transaction, according to an embodiment. At least one of the servers 101a begins execution of the method at 201.

At 202, a consumer using a consumer device 102 communicates with a central server 101a of the OMS 101 via first interface 101d to create an account, log into the OMS 101, and create a profile with personal preferences, collectively referred to herein as onboarding.

Turning briefly to FIG. 2B, a functional diagram of the system of FIG. 1A is provided for onboarding a new consumer at 202. Functionally, OMS 101 includes central servers 101a, contractual obligation engine (COE) 101b, and databases (DB) 101c, for integrating and automating financial and legal transactions between consumer devices 102 via a first interface 101d, financial institutions 104 (e.g., banks, credit card companies, on-line payment companies, and the like) via a second interface 101e, local property management servers (LPMS) 103 via a third interface 101f, and third-party service providers 105 via a fourth interface 101g. However, before a consumer can utilize the OMS functionality, the consumer must first be onboarded. The onboarding stage at 202 is a prerequisite to providing a user access to the OMS 101 and in particular access to select, change and move properties while retaining equity and ownership rights. As shown in FIG. 2B, onboarding stage 111, which may be external to the OMS 101 or incorporated into central server 101a, and uses an identity verification module 112, which can be an identity certification API, to facilitate communication with the consumer via the first interface 101d for taking a user identity photograph, ID match (e.g. driver's license, passport, etc.), a financial institution verification module 113, which can be an financial authorization APIs such as VoPay™ or Plaid™, to facilitate communication with the financial institutions 104 via the second interface 101e. FIG. 2B also shows a digital document collection module 214 for collecting digital documents.

Returning to FIG. 2A, the onboarding data may then be stored in a Consumer Profile DB 101c. In one embodiment, the onboarding process at 202 creates an account with the OMS 101 including username, password, two-factor authentication login data, legal first and last names, residence address, date of birth, verification document (e.g., one or more of government issued driver's license, passport, health card, etc.), financial institution authorization security links, employment and/or annual income, amongst other personal information and optional personal preferences.

Once the user has logged in to the OMS 101 by entering username and password, then at 203, the consumer creates a request to purchase ownership of a property. In one embodiment, the consumer may preferably use a graphical user interface provided by the OMS 101, while in other embodiments the consumer may use a voice activated system under control of the server that recognizes and responds to verbal commands from the consumer.

At 204, the consumer provides preferences for desired location, a move in date, property type, size and living arrangements, which are communicated via the graphical user interface or voice activated system. In one embodiment of the invention consumer may provide a preference for desired location, a preferred move in date and or alternate move in date, property type e.g., apartment, one story, two story, etc. size, e.g., 1200 square feet and living arrangements e.g., 2 bedrooms and 2 washrooms or 3 bedrooms, 2 washrooms and a powder room etc.

Accordingly, the consumer request to purchase ownership of a property is characterized by consumer preferences selected by filtering property criteria including one or more of a desired location, move in date, alternate move in date, property type, size and living arrangements.,

The central server 101a of the OMS 101 receives the consumer request via the first interface 101d, and in response searches an Available ODRE DB at 205 for any available property according to the filtered property criteria for matching the selected consumer preferences.

In one embodiment of the invention system only searches the availability database (Available ODRE) for properties that are currently lying vacant but may also consider what properties may become available in the future given that some consumers may be selling and moving out while others may be moving to a different property.

At 206, the OMS 101 selects one or more of the properties that meet the consumer preferences. The central server 101a of the OMS 101 then transmits via the first interface 101d at least one property proposal to the consumer device 102, wherein the property proposal matches at least one of the filtered property criteria.

In one embodiment, the consumer may only be shown properties that fully match the consumer provided criteria. In another embodiment, the consumer may be shown properties that match some but not necessarily all of the consumer provided criteria. In a further embodiment, if no property in the system fully or partially matches the consumer provided criteria then the consumer may optionally be shown properties that are available or will become available in the future.

At 207, the consumer issues a reservation request to reserve at least one of the selected properties using the graphical user interface or voice activated system and at 208 provides financial details in support of the reservation request such as personal identification, current and previous address(es) over a given time period e.g., last 5 years, banking information, credit history, credit score, country of residence and residency status for taxation purposes.

Upon receipt of the reservation request via the first interface 101d, at 209, OMS 101, via at least one of the servers 101a, communicates with at least one of the financial institutions 104 via second interface 101e to request a financial transaction to secure consumer funds using, for example, secure communications according to PCI data security standards.

Upon approval, OMS 101 receives from the least one of the financial institutions 104 via second interface 101e, the financial transaction to obtain consumer funds, for example, in the form of government backed currencies such as U.S. Dollar (USD), European Euro (EUR), Japanese Yen (JPY), British Pound (GBP), Swiss Franc (CHF), Canadian Dollar (CAD) etc., or cryptocurrencies such as Bitcoin, Litecoin, Ethereum, Zcash, Monero etc., or a combination of transactions made up of one or more paper/digital and/or one or more cryptocurrencies. A financial transaction may be conducted by use of cheque, draft, money ODRE, wire transfer, email transfer, direct deposit etc. The invention may use any one or a combination of several types and is not limited to this exemplary list.

At 210, OMS 101 completes the consumer transaction, including execution of a contract signed by the consumer using, for example an API into a secure digital document application like HelloSign™, and records it in the ODRE Ownership DB 101c, as a written contract, electronic contract stored on a local server or cloud server, or a, which is a self-enforcing agreement embedded in computer code managed by a blockchain. The code contains a set of rules under which the parties of that agree to interact with each other. If and when the predefined rules are met, the agreement is automatically enforced. s provide mechanisms for efficiently managing tokenized assets and access rights between two or more parties. The underlying values and access rights are stored on the blockchain, which is a transparent, shared ledger, where they are protected from deletion, tampering, and revision. s, therefore, provide a public and verifiable way to embed governance rules and business logic in a few lines of code, which can be audited and enforced by the majority consensus of a P2P network.

At 211, OMS 101 allocates at least one property for occupancy on an ownership basis and updates the availability database (Available ODRE DB) 101c to remove availability of the reserved property.

At 212, OMS 101 transmits to the consumer via the first interface 101d confirmation of the regarding the completion of the financial and ownership transactions and the ownership rights and occupancy rights associated therewith, and notification of a date of occupancy start.

At 213, OMS 101 provides notification to LPMS 103 via the third interface 101f regarding change of ownership and move in date.

In one embodiment, OMS 101 may directly or via the LPMS 103 be in communication with one or more third party service providers 105 and may engage one or more of these third-party services on behalf of the consumer e.g., engaging a moving company to assist the consumer to move to the reserved property and a cleaning service prior to moving into the reserved property. Other third-party services associated with occupancy of the reserved property may include at least one child care company, at least one pet care company, etc. Upon consumer selection of a third-party service, the system engaging desired third-party service providers (i.e. OMS 101 or LPMS 103) is further configured to provide notifications detailing date and time and other preferences to the consumer, selected third parties and local ODRE management personnel associated with the reserved property through the LPMS 103, and also configured to conduct a financial transaction, as discussed at 208 and 209, by deducting funds from the consumer account, transferring funds to the selected third party's account after the completion of the service and preferably retaining a portion of the funds for facilitating and supervising the engagements.

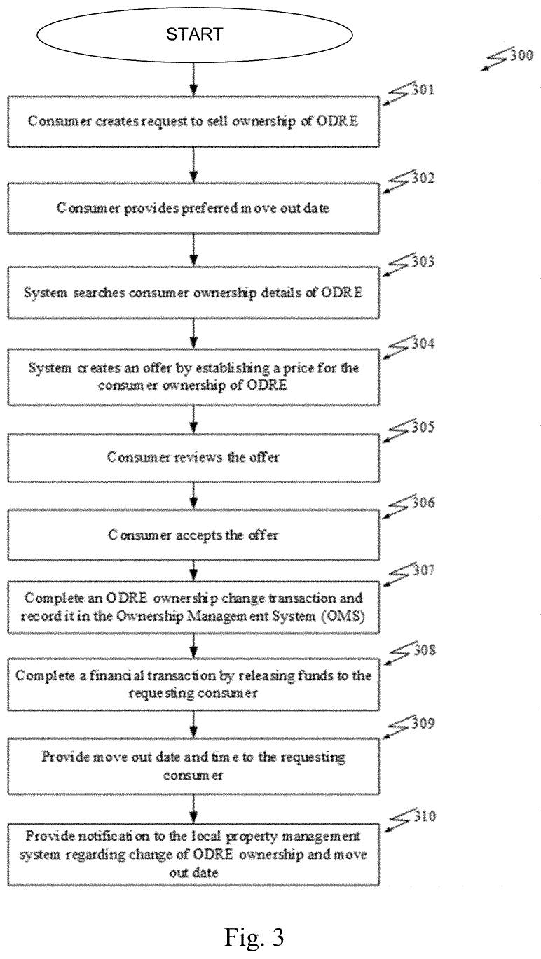

FIG. 3 is a flowchart showing a method implemented by OMS 101 for facilitating a consumer financial and ownership transaction, namely selling ownership of a property, according to an additional embodiment.

At 301, a consumer using a consumer device 102 communicates with a central server 101a of the OMS 101 via the first interface 101d to create a request to sell ownership of a property. In one embodiment, the consumer may preferably use a graphical user interface provided by the OMS 101, while in other embodiments the consumer may use a voice activated system under control of the server that recognizes and responds to verbal commands from the consumer.

At 302, the consumer provides preferences for a move out. In one embodiment, the consumer may be given the option to provide a preferred move out date and an alternative move out date.

The central server 101a of the OMS 101 receives the consumer request via the first interface 101d, and in response at 303, searches consumer ownership details in an ODRE Ownership DB 101c for any associated with the consumer account. In another embodiment of the invention the system searches consumer ownership details of ODRE in a digital contract associated with the consumer account.

The central server 101a of the OMS 101 creates an offer at 304 by establishing a price for the consumer ownership of the property and transmits the offer to the consumer device 102 via the first interface 101d. In one embodiment, establishing the price may involve Artificial Intelligence (AI) and Machine Learning (ML) techniques.

The consumer reviews the offer at 305, for example using the graphical user interface or another type of user interface e.g. voice, and at 306 accepts the offer, preferably by agreeing to the terms and conditions and digitally signing the contract.

Upon receipt of the accepted offer via the first interface 101d, at 307, OMS 101, via at least one of the servers 101a, completes the ownership change transaction and at records as a using blockchain technology, as discussed above it in the ODRE Ownership DB 101c.

At 308, OMS 101 completes a financial transaction with a respective one of the financial institutions 104 by releasing funds to the requesting consumer. In one embodiment, OMS 101 stores the details of the financial transaction in the smart contract stored in the ODRE Ownership DB 101c.

At 309, OMS 101 transmits to the consumer via the first interface 101d confirmation of the regarding the completion of the financial and ownership transactions, and notification of move out date. In one embodiment of the invention the system provides a move out date and time to the requesting consumer.

At 310, OMS 101 provides notification to LPMS 103 via the third interface 101f regarding change of ownership and move out date.

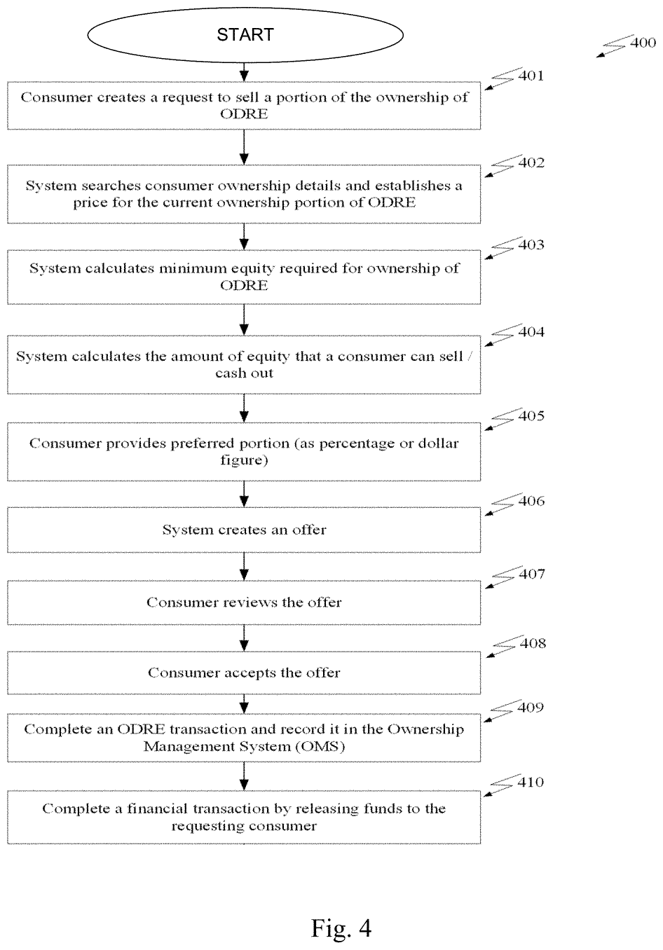

FIG. 4 is a flowchart showing a method implemented by OMS 101 for facilitating a consumer financial and ownership transaction, namely selling a portion of ownership of a property, according to an additional embodiment.

At 401, a consumer using a consumer device 102 communicates with a central server 101a of the OMS 101 via the first interface 101d to create a request to sell a portion of ownership of a property. In one embodiment, the consumer may preferably use a graphical user interface provided by the OMS 101, while in other embodiments the consumer may use a voice activated system under control of the server that recognizes and responds to verbal commands from the consumer.

At 402, OMS 101 searches consumer ownership details in ODRE Ownership DB 101c and establishes a price for the current ownership portion of the property. In one embodiment, OMS 101 searches consumer ownership details preferably in the associated with the consumer account and establishes a price for the current ownership portion of the property.

At 403, OMS 101 calculates minimum equity required for ownership of the property and at 404 calculates minimum Equity Required for Ownership (ERO) of the property and the amount of equity that a consumer can sell/cash out. In one embodiment, the amount of equity that a consumer can sell/cash out is calculated preferably by subtracting minimum Equity Required for Ownership (ERO) of the property from the price for the current consumer ownership portion of the property.

At 405, the consumer provides a preferred portion (as percentage or dollar figure) of the current ownership that they want to sell/cash out.

The central server 101a of the OMS 101 creates an offer at 406 and transmits the offer to the consumer device 102 via the first interface 101d. In one embodiment, the offer is transmitted in an electronic form e.g. an e-mail with attached electronic documents e.g. PDF versions. While in another embodiment, the consumer may be prompted to log into the OMS 101 and review the offer using the graphical user interface.

The consumer reviews the offer at 407, for example using the graphical user interface or another type of user interface e.g., voice, and at 408 accepts the offer, preferably by agreeing to the terms and conditions and digitally signing the contract. In one embodiment, a time period may be allocated for the consumer to review the offer, while in another embodiment a deadline may be imposed such that if the offer is not reviewed before the deadline the offer expires.

Upon receipt of the accepted offer via the first interface 101d, at 409, OMS 101, via at least one of the servers 101a, completes the ownership change transaction and records it as a smart contract using blockchain technology, as discussed above in the ODRE Ownership DB 101c.

At 410, OMS 101 completes a financial transaction with a respective one of the financial institutions 104 by releasing funds to the requesting consumer and optionally depositing these funds in the consumer's financial institution of choice. In one embodiment, OMS 101 stores the details of the financial transaction in the smart contract stored in the ODRE Ownership DB 101c.

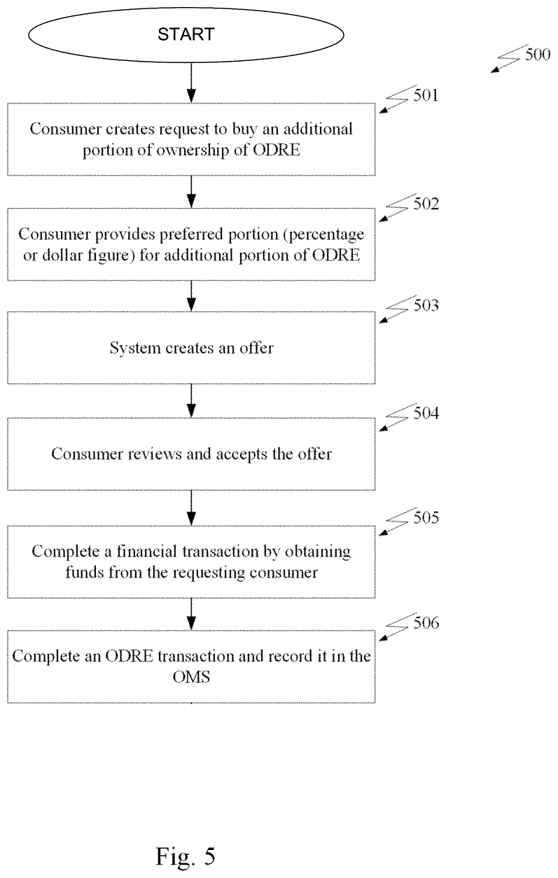

FIG. 5 is a flowchart showing a method implemented by OMS 101 for facilitating a consumer financial and ownership transaction, namely a consumer request to buy an additional portion of ownership of a property.

At 501, a consumer using a consumer device 102 communicates with a central server 101a of the OMS 101 via the first interface 101d to create a request to buy an additional portion of ownership of a property. In one embodiment, the consumer may preferably use a graphical user interface provided by the OMS 101, while in other embodiments the consumer may use a voice activated system under control of the server that recognizes and responds to verbal commands from the consumer.

At 502, the consumer provides a preferred portion (percentage or dollar figure) for the additional portion (e.g. as a percentage or dollar amount).

At 503, the central server 101a of the OMS 101 creates an offer at and transmits the offer to the consumer device 102 via the first interface 101d. In one embodiment, the offer is transmitted in an electronic form e.g. an e-mail with attached electronic documents e.g. PDF versions. While in another embodiment, the consumer may be prompted to log into the OMS 101 and review the offer using the graphical user interface.

The consumer reviews the offer at 504, for example using the graphical user interface or another type of user interface e.g. voice, and accepts the offer, preferably by agreeing to the terms and conditions and digitally signing the contract. In one embodiment, a time period may be allocated for the consumer to accept the offer, while in another embodiment a deadline may be imposed such that if the offer is not accepted before the deadline the offer expires.

Upon receipt of the accepted offer via the first interface 101d, at 505, OMS 101 completes a financial transaction with a respective one of the financial institutions 104 for obtaining funds from the requesting consumer. In one embodiment, OMS 101 stores the details of the financial transaction in the smart contract stored in the ODRE Ownership DB 101c.

At 506, OMS 101 completes the ownership change transaction and records it as a smart contract using blockchain technology, as discussed above, in the ODRE Ownership DB 101c.

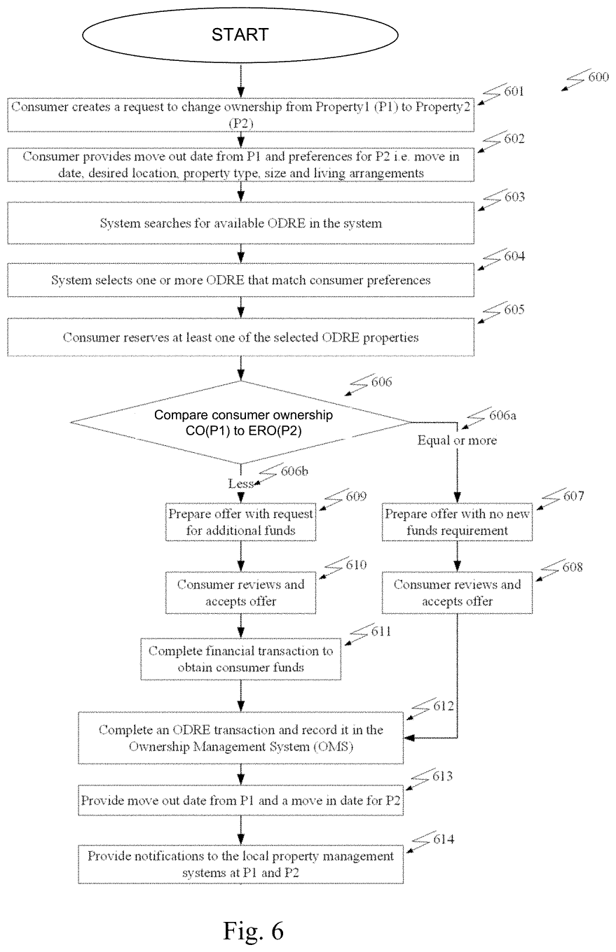

FIG. 6 is a flowchart showing a method implemented by OMS 101 for facilitating a consumer financial and ownership transaction, namely a consumer request to change ownership from a first property (P1) to a second property (P2) and move from the first to the second property.

At 601, a consumer using a consumer device 102 communicates with a central server 101a of the OMS 101 via the first interface 101d to create a request to change ownership from the first property (P1) to the second property (P2). In one embodiment, the consumer may preferably use a graphical user interface provided by the OMS 101, while in other embodiments the consumer may use a voice activated system under control of the server that recognizes and responds to verbal commands from the consumer.

At 602, the consumer provides a move out date from P1 and preferences for a move in date to P2, desired location, property type, size and living arrangements. In one embodiment of the invention consumer provides preferences for P2 including a desired location such as New York City, N.Y., a preferred move in date and or an alternate move in date, property type e.g. apartment, one story, two story, etc. size e.g. 2500 square feet and living arrangements e.g. 4 bedrooms and 3 washrooms or 4 bedrooms, 4 washrooms and a powder room etc.

The central server 101a of the OMS 101 receives the consumer request via the first interface 101d, and in response searches an available ODRE DB at 603 for any available property according to the filtered property criteria for matching the selected consumer preferences.

In one embodiment of the invention system only searches the availability database (Available ODRE) for properties that are currently lying vacant but may also consider what properties may become available in the future given that some consumers may be selling and moving out while others may be moving to a different property.

At 604, the OMS 101 selects one or more of the properties that meet the consumer preferences. The central server 101a of the OMS 101 then transmits via the first interface 101d at least one property proposal to the consumer device 102 for P2, wherein the property proposal matches at least one of the filtered property criteria.

In one embodiment, the consumer may only be shown properties that fully match the consumer provided criteria. In another embodiment, the consumer may be shown properties that match some but not necessarily all of the consumer provided criteria. In a further embodiment, if no property in the system fully or partially matches the consumer provided criteria then the consumer may optionally be shown properties that are available or will become available in the future.

At 605, the consumer issues a reservation request to reserve at least one of the selected P2 properties using the graphical user interface or voice activated system.

Upon receipt of the reservation request via the first interface 101d, at 606, OMS 101, via at least one of the servers 101a, compares consumer ownership CO(P1) to ERO(P2).

If consumer ownership CO(P1) is equal to or more than the ERO(P2) at 606a then at 607 OMS 101 prepares an offer with no new funds requirement, in which case the consumer can move out of property P1 and move into P2 without incurring any costs that are typically associated with buying and selling real estate e.g. agent commissions, land transfer taxes etc.

In an embodiment, OMS 101 may also allow a consumer to cash out some component of their ownership as the consumer owns more equity in ODRE P1 than what is required to move into ODRE P2.

At 608, the consumer reviews and accepts the offer, and the method continues to step 612 which is described below.

If consumer ownership CO(P1) is less than the ERO(P2) at 606b then then at 609 OMS 101 prepares an offer with request for additional consumer funds, since the consumer equity in the ODRE P1 is less than the Equity Required for Ownership in P2.

At 610, the consumer reviews and accepts the offer, for example by agreeing to the terms and conditions and digitally signing the contract. The details of the signed contract may be stored in a smart contract using blockchain technology, as discussed above. In one embodiment of the invention there may be a time period allocated so that the consumer can review the offer before accepting it. While in another embodiment of the invention there may be a deadline such that if the offer is not accepted during this time period the offer expires.

Upon receipt of the accepted offer via the first interface 101d, at 611, OMS 101 completes a financial transaction with a respective one of the financial institutions 104 for obtaining funds from the requesting consumer. In one embodiment, OMS 101 stores the details of the financial transaction in the smart contract stored in the ODRE Ownership DB 101c.

At 612, OMS 101 completes the ownership change transaction and records it as a smart contract using blockchain technology, as discussed above, in the ODRE Ownership DB 101c, and at 613 transmits to the consumer via the first interface 101d confirmation of the regarding the completion of the financial and ownership transactions and the ownership rights and occupancy rights associated therewith, and notification of a date for moving out of property P1 and of occupancy start for property P2.

At 614, OMS 101 provides notification to LPMS 103 at P1 and P2 via the third interface 101f regarding change of ownership and move in and move out dates.

According to an embodiment, contractual obligation engine (COE) 101b executes processes for computing various variables related to property ownership and propagates the same to owner-residents or the LPMS 103, as discussed below.

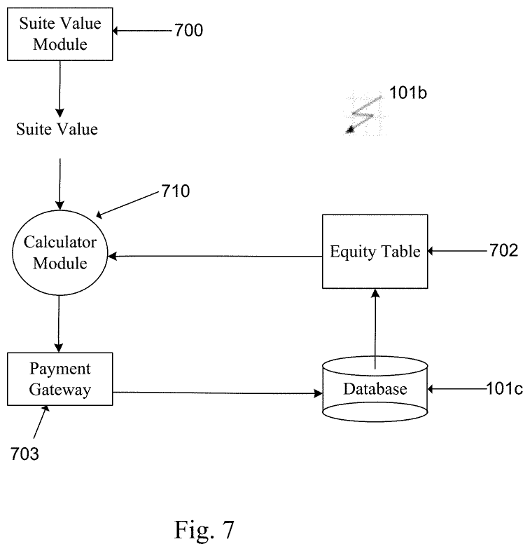

As shown in FIG. 7, COE 101b includes modules for implementing transactions within the OMS 101, including but not limited to establishing a price for consumer ownership of property at 304 and 402, amount of equity that a consumer can sell at 404, minimum equity required for ownership (ERO) in FIG. 6, as well as owner equity, property valuation, contractual obligations amounts, equity value adjustments, property portfolio equity, portfolio-based equity value adjustment value, contractual obligation adjustment factor and portfolio-based contractual obligation value, as discussed below.

The modules COE 101b include a suite value module 700, calculator module 710, equity table 702 and payment gateway 703.

Suite value module 700 can, for example, be a Building Stack™ API for processing property value and transmitting the suite value to the calculator module 710.

The equity table 702 is preferably a blockchain operating in conjunction with ODRE Ownership DB 101c, which provides state management for the COE 101b in terms of consumer equity position, payment obligations, etc.

Payment gateway 703 can, for example, be implemented by API access for electronic funds transfer (ETF) via system platforms such as Plaid™ and VoPay™, with required fault tolerance, logging etc., to enable financial transactions such as at steps 308, 410, 505 and 611, discussed above.

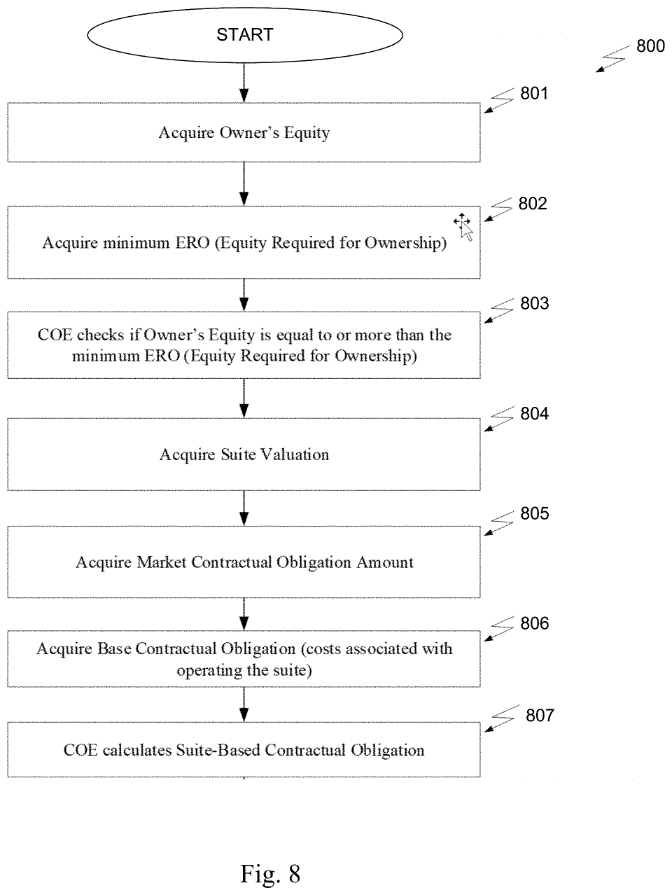

FIG. 8 is a flowchart showing a method 800 implemented by the COE 101b of FIG. 7 for calculating a suite-based contractual obligation value payable by the consumer, according to an embodiment, by summing a base payment value, referred to below as a base contractual obligation, and an additional payment value, referred to below as a market contractual obligation amount, such that the suite-based contractual obligation value represents a discount of the monthly contractual payment obligation value by a suite-based equity value adjustment that is related to a payment benefit coefficient.

At 801, a value for owner's equity is retrieved from blockchain equity table 702 using a pointer from ODRE Ownership DB 101c.

At 802, calculator module 710 determines a minimum ERO (equity required for ownership). In one embodiment, the minimum ERO can be obtained from a database in the OMS 101.

At 803, calculator module 710 determines if the owner's equity is equal to or more than the minimum ERO. In one embodiment, if the owner's equity is less than the minimum ERO the owner is notified and preferably is required to add funds so that owner's equity at least equals ERO.

At 804, the suite value is obtained from suite value module 700.

At 805, calculator module 710 receives the market contractual obligation amount from a database 101c in the OMS.

At 806, calculator module 710 receives the base contractual obligation value from a database 101c in the OMS, where the base contractual obligation value represents costs associated with operating the suite (property), such as a sum of costs associated with operating the suite in a given building. In one embodiment, all such costs associated with operating the suite and/or the building may be computed in real-time or regular intervals and stored in different databases in the OMS 101. In one embodiment, factors that may impact the costs of operating the suite or the building may be acquired in real-time from relevant third parties and may include but are not limited to future projected values e.g. rates of electricity, gas, taxes etc.

At 807, calculator module 710 calculates the suite-based contractual obligation value by summing the base contractual obligation value and the market contractual obligation amount and saves it to a database 101c of the OMS 101.

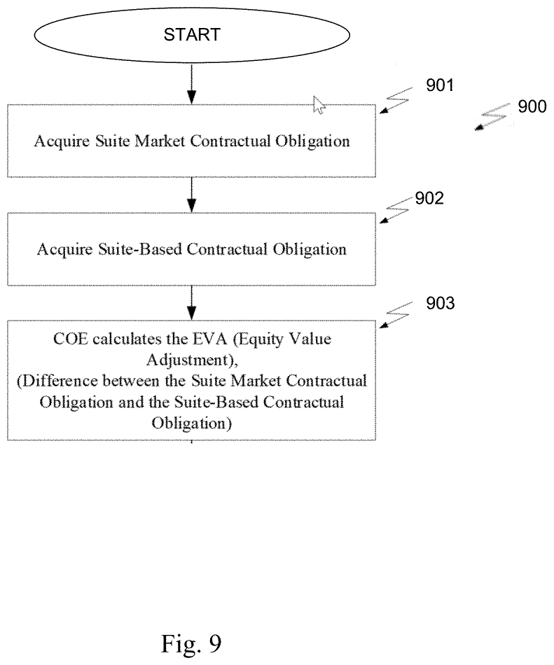

As discussed above, the suite-based contractual obligation value represents a discount of the monthly contractual payment obligation value by a suite-based equity value adjustment that is related to a payment benefit coefficient. FIG. 9 is a flowchart showing a method 900 implemented by the COE 101b of FIG. 7 for calculating the suite-based equity value adjustment.

At 901, a suite market contractual obligation is retrieved from a database 101c of the OMS 101. In an embodiment, the suite market contractual obligation is related to a payment benefit coefficient retrieved from the database representing consumer percent equity in the value of the property.

At 902, the calculator module 710 retrieves the suite-based contractual obligation value from a database 101c of the OMS.

At 902, the calculator module 710 calculates the suite-based equity value adjustment (EVA) by subtracting the suite-based contractual obligation from the suite market contractual obligation value and preferably saves it in a database 101c of the OMS 101.

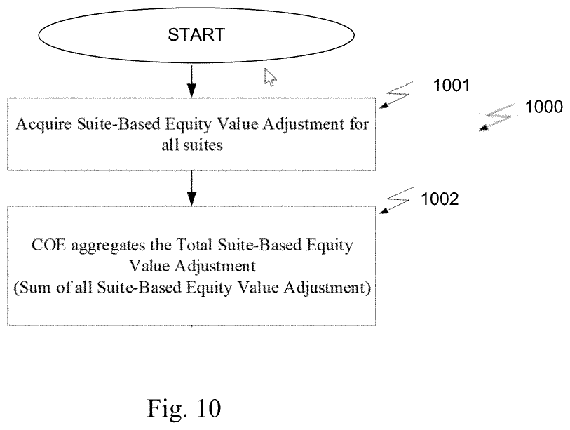

FIG. 10 is a flowchart showing a method 1000 implemented by the COE 101b of FIG. 7 for calculating a total all-suite-based equity adjustment value representing an aggregate payment benefit for all equity owners of a portfolio of properties.

At 1001, the calculator module 710 retrieves individual suite-based equity adjustment values for all properties in the portfolio from a database 101c of the OMS and, at 1002, aggregates the individual suite-based equity adjustment values to generate a total suite-based equity adjustment value and stores it in a database 101c of the OMS 101.

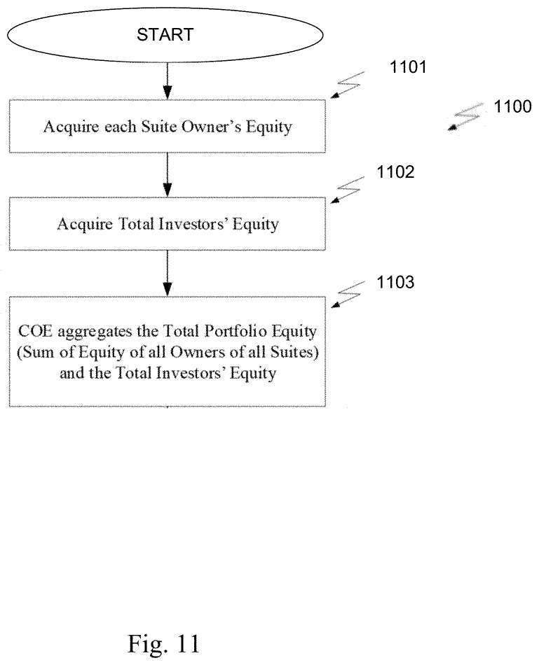

FIG. 11 is a flowchart showing a method 1100 implemented by the COE 101b of FIG. 7 for calculating total portfolio equity for the portfolio of properties.

At 1101, the calculator module 710 retrieves each suite owner's equity from suite value module 700 of the COE 101b.

At 1102, the calculator module 710 retrieves the total investors' equity from a database 101c of the OMS.

At 1103, the calculator module 710 aggregates the total portfolio equity which is the sum of all suite owners' equity and the total investors' equity and preferably saves it in a database 101c of the OMS 101.

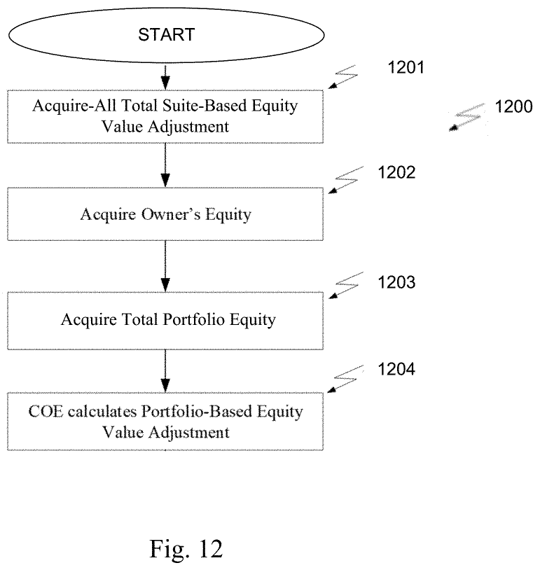

FIG. 12 is a flowchart showing a method 1200 implemented by the COE 101b of FIG. 7 for calculating a portfolio-based equity adjustment value.

At 1201, the calculator module 710 retrieves the total suite-based equity adjustment value generated at 1002 of FIG. 10.

At 1202, the calculator module 710 retrieves the suite owner's equity from suite value module 700 of the COE 101b.

At 1203, the calculator module 710 retrieves the total portfolio equity.

At 1204, calculator module 710 calculates a portfolio-based equity adjustment value by multiplying the total all-suite-based equity adjustment value by the total portfolio equity and preferably saves it in a database 101c of the OMS 101.

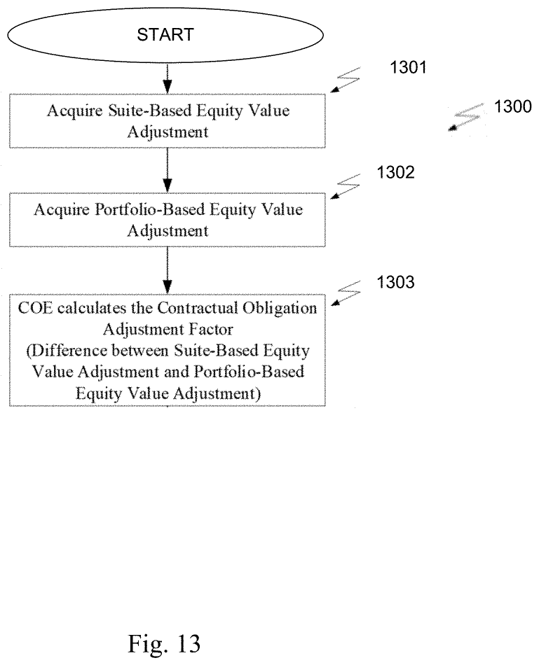

FIG. 13 is a flowchart showing a method 1300 implemented by the COE 101b of FIG. 7 for calculating a contractual obligation adjustment factor.

At 1301, the calculator module 710 retrieves the suite-based equity adjustment value generated at 1002 of FIG. 10.

At 1302, the calculator module 710 retrieves the portfolio-based equity adjustment value generated at 1204 of FIG. 12.

At 1303, calculator module 710 calculates the contractual obligation adjustment factor by subtracting the portfolio-based equity adjustment value from the suite-based equity adjustment value, and preferably saves it in a database 101c of the OMS 101.

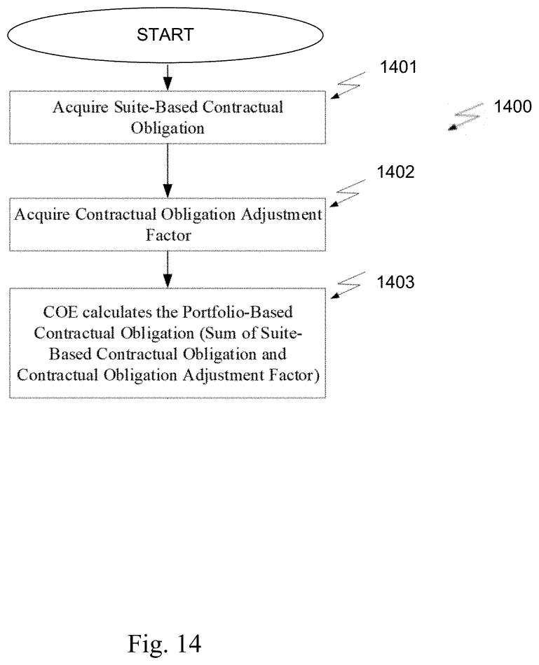

FIG. 14 is a flowchart showing a method 1400 implemented by the COE 101b of FIG. 7 for calculating a portfolio-based contractual obligation value.

At 1401, the calculator module 710 retrieves the suite-based contractual obligation value generated at 807 of FIG. 8.

At 1402, the calculator module 710 retrieves the contractual obligation adjustment factor generated at 1303 of FIG. 13.

At 1403, calculator module 710 calculates the portfolio-based contractual obligation value payable by the consumer by summing the suite-based contractual obligation value and contractual obligation adjustment factor, and preferably saves it in a database 101c of the OMS 101.

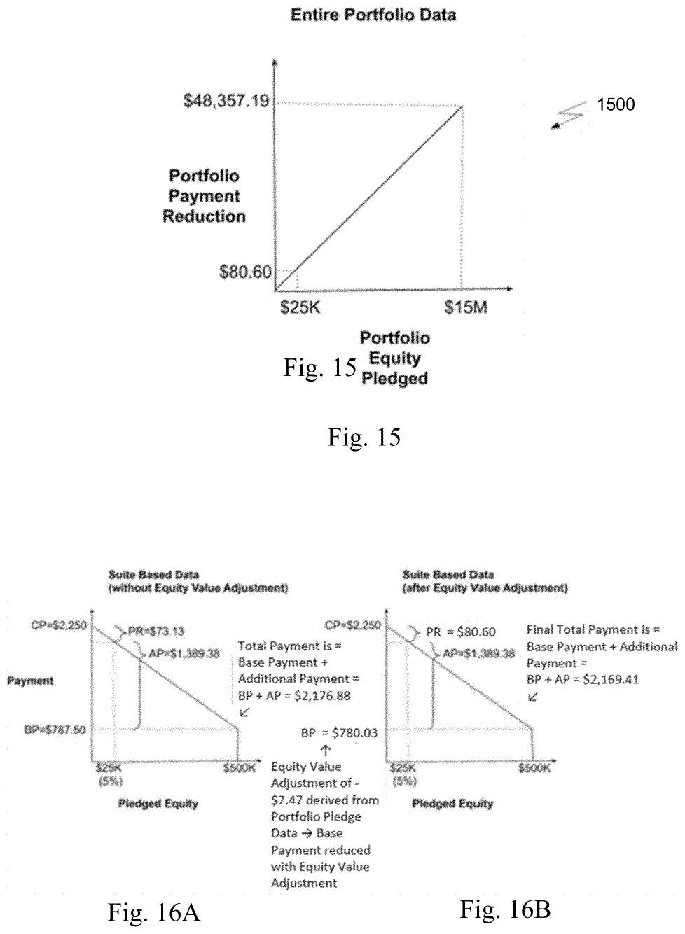

In ODRE to illustrate the operating principles of the COE 101b according to the methods 800, 900, 1000, 1100, 1200, 1300 and 1400, an example is provided, with reference to FIGS. 15 and 16.

In this example, a consumer acquires ownership of a property, for example according to the method 200 set forth in FIG. 2, by pledging $25,000. At the time of her occupancy, the value of the consumer's suite is $500,000, the contractual payment for the suite CP=$2,250 per month, and the costs associated with operating the suite is: BP_{α,β=0}=$787.5 per month, as depicted in FIG. 16A. Furthermore, there is $15,000,000 in equity pledged across all owner-residents who receive an aggregate payment benefit of $48,357.19 as shown at a graph 1500 in FIG. 15, which represents the total all-suite-based equity value adjustment discussed with reference to FIG. 10. For simplicity, a minimum income reserve for the suite is α=0.

A payment benefit coefficient for consumer may be calculated as

$$ρ = \frac{\$25 , 000}{\$500 , 000} = 5 \%$$

The additional payment after applying the payment benefit coefficient is: AP=(1−0.05)(2,250−787.5)=$1,389.38.

The suite-based equity value adjustment (FIG. 9) is: Pₛ=$2,250−$1,389.38−$787.5=$73.12

A payment pledge coefficient may be calculated as:

$$σ = \frac{\$25 , 000}{\$15 , 000.000} = 0.17 \% ,$$

where the consumer's pledge of $25,000 is included in an owner-resident pledge pool.

The portfolio-based equity value adjustment (FIG. 12) is: [symbol] =0.17%*$48,357.19=$80.60.

As discussed above, it is assumed that the minimum income reserve is: α=0.

The contractual obligation adjustment factor (FIG. 13) is: β=$73.12−$80.60=−$7.47

The discounted base payment becomes: BP=$787.50−$7.47=$780.03, as shown in FIG. 16B.

The total portfolio-based contractual obligation for the consumer therefore becomes: P=$780.03+$1,389.38=$2,169.40 and the consumer's payment reduction benefit becomes: PR=$2,250−$2,169.40=$80.60, as shown in FIG. 16B.

Therefore, in the first month of occupancy, Sarah would receive a payment reduction benefit of $80.60 on her pledge of $25,000.

Although a linear relationship is illustrated in FIG. 15, in other embodiments COE 101b may use parabolic, quadratic, hyperbolic logarithmic or other kinds of relationship graphs.

The system 100 may be further adapted for other functionality. In particular, in the system 100, certain changes to equity indicators (e.g. which may indicate and/or represent a pledge made by an equity owner) may occur based on activities associated with equity owners of the properties (e.g. suites) described herein (e.g. of which suites at a property P1, property P2, etc., are but one example). Such activities may include, but are not limited to, transactions, equity exchanges, and the like. Indeed, hereafter, reference to a property and/or a particular property may be understood, in some examples, to comprise a suite and/or suites at a property P1, property P2, etc., and the like.

However, to accomplish such transactions and/or exchanges of equity, and the like, associated with activities of equity owners of the properties, manual-based operation of various communication devices, and/or computing devices, may need to occur, to initiate messaging in the system 100. Alternatively, and/or in addition, use of printers, and the like, may be required to print cheques, and/or other types of documents, that may be used to conduct transactions and/or exchanges of equity associated with equity owners of the properties. Such messaging, printing, and the like may lead to increases in bandwidth between the components of the system 100, waste of paper, and/or general waste of processing and/or physical resources in the system 100. As will be described hereafter, the system 100 may be adapted to mitigate such a waste of processing and/or physical resources and/or to minimize bandwidth within the system 100.

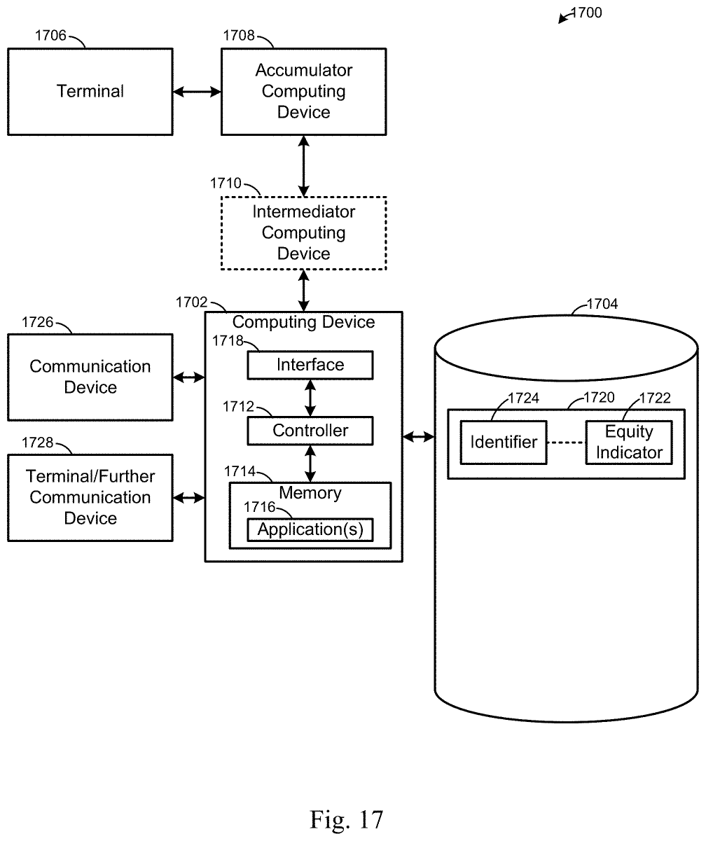

For example, attention is next directed to FIG. 17 which depicts a system 1700, that may comprise the system 100 and/or a portion of the system 100, but adapted for functionality related to changing periodic payment requests for particular properties relative to previous payment requests, to indicate changes to equity indicators, as described hereafter. The various components of the system 1700 are in communication via any suitable combination of wired and/or wireless communication links, and communication links between components of the system 1700 are depicted in FIG. 17, and throughout the present specification, as double-ended arrows between respective components; the communication links may include any suitable combination of wireless and/or wired links and/or wireless and/or wired communication networks, and the like.

It is furthermore understood that the various messages and/or data and/or indicators, and the like, provided between components of the system 1700 may occur via Application Programming Interfaces (APIs).

Similarly, it is furthermore understood that the various messages and/or data and/or indicators, and the like, provided between components of the system 1700 may occur and/or be initiated via applications and/or “apps” at various suitable components of the system 1700.

Furthermore, herein, the term “fungible amount” is understood to include amounts of any suitable type that may be exchanged for goods, services, and the like, and/or converted into other types of fungible amounts of a same type, or a different type. For example, a fungible amount of currency (which may include, but is not limited to, cryptocurrency) may be exchanged for goods, services. Similarly, a fungible amount of points may be exchanged for goods, services. Similarly a fungible amount of a first type may be converted into a fungible amount of a second type different from the first type. Furthermore, while fungible amounts are understood to be easily exchangeable and/or interchangeable, it is further understood that such fungible amounts may be converted to non-fungible items and/or amounts, such as certain types of non-fungible tokens that may be represented by equity indicators described herein

It is further understood that while some components of the system 1700 are described with respect to components of the system 100, other components of the system 1700 are provided in addition to the components of the system 100. Furthermore, while not all components of the system 100 are described with respect to the system 1700, such components may nonetheless be present at the system 1700. For example, while not depicted in FIG. 17, the system 1700 may generally comprise the local property management systems 103, the financial institutions 104, the third party service providers 105, etc.

In particular, the system 1700 comprises a computing device 1702 which may comprise one or more of the servers of the system 100 (e.g. the server 101a and/or the server 101b), and/or one or more other servers, and/or one or more cloud computing devices, and the like.

The system 1700 further comprises a memory 1704 which may comprise one or more of the databases 101c of the system 100, and/or one or more other memories and/or databases. Furthermore, while the memory 1704 is provided in the form of a database, the memory 1704 may be provided in any suitable format.

The system 1700 further comprises a terminal 1706, which may comprise a point-of-sale (POS) terminal and the like, which may be located at a retail store, and the like, and which may be used for certain types of transactions including, but not limited to, purchase of goods and/or services. In some examples, the terminal 1706 may comprise a communication device, such as a mobile phone, adapted for terminal functionality via an application, and/or hardware (e.g. such as a near field communication transceiver, a Square™ device, and the like). In some examples, the terminal 1706 may be in communication with servers and/or computing devices of the financial institutions 104, and the like, and/or operating digital wallets, which may be used to complete transactions. However, as depicted, the system 1700 further comprises an accumulator computing device 1708, and the terminal 1706 is in communication with the accumulator computing device 1708. In general, the accumulator computing device 1708 may comprise one or more servers and/or cloud computing devices that may accumulate fungible amounts of a first type on the basis of transactions that occur at the terminal 1706, and/or other terminals (e.g. the system 1700 may comprise any suitable number of terminals).

For example, the accumulator computing device 1708 may be configured to accumulate “points” and/or “loyalty points” and the like, for example, on the basis of amounts of currency-based transactions that may occur at the terminal 1706 and/or other terminals; in these examples, fungible amounts of a first type may comprise such points, and the like. Furthermore, as such, the accumulator computing device 1708 may comprise a points accumulator computing device. However, the accumulator computing device 1708 may accumulate fungible amounts of a first type that is any suitable type that may be, however, different from currency-based fungible amounts.

In particular, when a transaction occurs at the terminal 1706, an amount (e.g. a currency-type amount) of the transaction may be provided to the accumulator computing device 1708, with an identifier of a user, and the like, associated with the transaction; such an identifier may comprise a loyalty card number associated with the user, and/or a name of the user, and/or any other suitable identifier. Hereafter, unless otherwise indicated, such a user may be an equity owner of a property described herein.

In a particular example, an equity owner may be presented with the terminal 1706 to conduct a transaction of a given currency amount, and, in addition to conducting the transaction, “tap” a loyalty card (e.g. a radio frequency identifier (RFID) configured card, and the like, at which is stored an identifier of the user), and the like, at the terminal 1706. The terminal 1706 may receive the identifier from the card, along with an associated given currency amount of the transaction, and provide (e.g. transmit) the identifier, along with the associated given currency amount, to the accumulator computing device 1708. However, the identifier may be received at the terminal 1706 in any suitable manner including, but limited to, swiping a card, tapping a communication device equipped with near field communication (NRC), manual input-device based entry, and the like, with the terminal 1706 adapted accordingly.

The accumulator computing device 1708 may convert the associated amount into a fungible amount of a first type, such as points, and add the fungible amounts of the first type to other fungible amounts of a first type associated with the identifier. Hence, for example, the user may accumulate points and/or any other suitable fungible amounts of a first type, at the accumulator computing device 1708. While not depicted, it is understood that the accumulator computing device 1708 may maintain a record (e.g. at a memory, not depicted) of a total fungible amount of a first type associated with the identifier.

Furthermore, the accumulator computing device 1708 may be configured to automatically transfer any points (and/or a portion thereof), and/or any other fungible amounts and any suitable first type, associated with an equity owner, and/or a given portion (e.g. a given percentage) thereof, to the computing device 1702 (e.g. any account used to accumulate such points debited accordingly). For example, an equity owner may have registered with the accumulator computing device 1708 to cause the accumulator computing device 1708 to function accordingly. Alternatively, when the loyalty card, and the like, is tapped, and the like, at the terminal 1706, the terminal 1706 may present an option (e.g. at a display screen thereof) to transfer any points (and/or a portion thereof) accumulated in an associated transaction to the computing device 1702. Alternatively, when the loyalty card, and the like, is tapped, and the like, at the terminal 1706, the terminal 1706 may communicate with the computing device 1702 (e.g. via one or more of the computing devices 1708, 1710 (described in more detail below), which transmits a message to confirm transfer of points to a communication device of the equity owner (e.g. such as the communication device 1726, described in more detail below) to confirm transfer any points (and/or a portion thereof) accumulated in an associated transaction to the computing device 1702; such a message may be provided in an application (e.g. an “app”) at the communication device of the equity owner with an option to confirm and, once an option to confirm is selected (e.g. and/or automatic confirmation has been selected as a setting in the app), the communication device of the equity owner may transmit a confirmation message back to the terminal 1706 and/or the accumulator computing device 1708 (e.g. via the computing devices 1702, 1708) which causes the accumulator computing device 1708 to transfer any points (and/or a portion thereof), and/or any other fungible amounts and any suitable first type, associated with the equity owner, and/or a given portion (e.g. a given percentage) thereof, to the computing device 1702.

Hence, an equity owner may have further registered with the computing device 1702 to cause the computing device 1702 to apply points (and/or any other fungible amounts and any suitable first type) to a pledge on a particular property, as described in more detail below.

As depicted, the system 1700 further comprises an intermediator computing device 1710, which may be optional, and/or the functionality of the intermediator computing device 1710 may be incorporated into the accumulator computing device 1708 and/or the computing device 1702. Regardless, the accumulator computing device 1708 is understood to be in communication with the computing device 1702, and, as depicted, the accumulator computing device 1708 is in communication with the computing device 1702 via the intermediator computing device 1710. The intermediator computing device 1710, and the like, may comprise one or more servers and/or cloud computing devices configured to convert fungible amounts of a first type into other types of fungible amounts. For example, while “points” and the like, may be accumulated by converting transaction amounts from the terminal 1706 into points at the accumulator computing device 1708, such points may further have an assigned value that may be different from, and/or unrelated to, the transaction amount; furthermore, such assigned values may fluctuate with time (e.g. and may have a market-value). Hence, for example, the intermediator computing device 1710, and the like, may be configured to convert fungible amounts of a first type to other types of fungible amounts indicative of fungible amounts of the first type, and provide such fungible amounts of the first type and/or the other types of fungible amounts which are indicative of fungible amounts of the first type, to the computing device 1702, along with an identifier associated with a particular property. As such, in these examples, the intermediator computing device 1710 may comprise a points intermediator computing device.

The identifier associated with a particular property may be the same identifier provided by the transaction terminal 1706, which is associated with an equity owner that owns equity in the particular property, and/or the identifier may be any other suitable identifier. Alternatively, the computing device 1702 may store an association between an identifier provided by the transaction terminal 1706 and another identifier associated with the same equity owner that is used by the computing device 1702 to identify the equity owner and an associated property (e.g. an identifier 1724 described in more detail below). Hence, regardless of format, the identifier received from the one or more of the computing devices 1708, 1710 is understood to be associated with a particular property (e.g. and which may occur via a relational chain of associations of various identifiers available to the computing device 1702, for example as stored at the memory 1704). Such a relational chain of the various identifiers may be generated during a registration process (e.g. where an equity owner registers with the computing device 1702 to apply fungible amounts of a first type to a pledge, and the like, for a particular property); in such a registration process, the equity owner may, via communication device, register their loyalty points card identifier, and the like, against an identifier associated with the equity owner, and/or a particular property.

Regardless, the computing device 1702 is understood to receive: an indication of: a first fungible amount of a first type; and a particular property. Put another way, while an indication of a particular property is described herein with respect to an identifier, an indication of a particular property may be of any suitable format and/or type.

Details of the computing device 1702 will next be described. As previously described, the computing device 1702 may comprise one or more servers, one or more cloud computing devices, and the like. As such, the functionality described with respect to the computing device 1702 may be distributed “in the cloud” and/or geographically, and the like.

The computing device 1702 generally comprises a processor and/or a controller 1712, a memory 1714 storing at least one application 1716, and a communication interface 1718. The controller 1712 is understood to be communicatively coupled to other components of the computing device 1702. Hereafter, the at least one application 1716 will be interchangeably referred to as the application 1716.

The communication interface 1718 may include one or more wired and/or wireless input/output (I/O) interfaces that are configurable to communicate with other components of the system 1700 (and/or the system 100). For example, the communication interface 1718 may include one or more wired and/or wireless transceivers for communicating with other suitable components of the system 1700 (and/or the system 100) using any suitable one or more communication links and/or communication wired and/or wireless networks.

The controller 1712 may include one or more logic circuits, one or more processors, one or more microprocessors, one or more CPUs, and/or one or more GPUs, and/or the controller 1712 may include one or more ASIC (application-specific integrated circuits) and/or one or more FPGA (field-programmable gate arrays), and/or another suitable electronic device. In some examples, the controller 1712 and/or the computing device 1702 is not a generic controller and/or a generic device, but a device specifically configured to implement functionality for changing periodic payment requests for particular properties relative to previous payment requests, to indicate changes to equity indicators. For example, in some examples, the controller 1712 and/or the computing device 1702 specifically comprises a computer executable engine configured to implement functionality for changing periodic payment requests for particular properties relative to previous payment requests, to indicate changes to equity indicators.

The memory 1714 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 17, programming instructions (e.g., machine readable instructions) that implement the functionality of the computing device 1702 as described herein are maintained, persistently, at the memory 1714 and used by the controller 1712, which makes appropriate utilization of volatile storage during the execution of such programming instructions.

Furthermore, the memory 1714 stores instructions corresponding to the at least one application 1716 that, when executed by the controller 1712, enables the controller 1712 to implement functionality for changing periodic payment requests for particular properties relative to previous payment requests, to indicate changes to equity indicators, including but not limited to, blocks of methods set forth hereafter.

In illustrated examples, when the controller 1712 executes the one or more applications 1716, the controller 1712 is enabled to: receive an indication of: a first fungible amount of a first type; and a particular property; identify an equity indicator associated with the identifier; convert the first fungible amount of the first type into a second fungible amount of a second type, different from the first type, the second type associated with property value; cause the equity indicator to change by an amount related to the second fungible amount of the second type; and change a periodic payment request for the particular property, providable to a communication device associated with the indicator, relative to a previous payment request, to indicate the change to the equity indicator.

In yet further examples, the controller 1712 implementing one or more of the applications 1716 may be configured to implement one or more of the modules 700, 710, and/or the payment gateway 703 of FIG. 7.

While details of the computing devices 1708, 1710 and the terminal 1706 are not depicted, the computing devices 1708, 1710 and the terminal 1706 may have components similar to the computing device 1702 but adapted, for the respective functionality thereof. For example, the terminal 1706 may include: a card reader and/or an NRC reader to read a loyalty card and/or an NRC-based data from a communication device, and the like; and a controller (and/or processor) and a memory storing suitable applications to implement functionality of the terminal 1706; and a communication interface to communicate with the accumulator computing device 1708, and the like.

The memory 1704 is next described.

In particular, as depicted, the memory 1704 may comprise a database, and the memory 1704 may be a component of another computing device (not depicted), at which the memory 1704 is stored. Alternatively, the memory 1704 may be at least partially incorporated into the memory 1714 of the computing device 1702.

Regardless, as depicted, the memory 1704 is understood to include portions, such as a portion 1720, which may be controlled to physically change state, for example to store and/or change certain components thereof. While reference is made to one portion 1720, it is understood that such a portion 1720 may comprise a plurality of portions (e.g. sectors) of the memory 1704. For example, as depicted, the memory 1704 stores, at the portion 1720, an equity indicator 1722 in association with an identifier 1724 (such an association indicated by a dashed line therebetween, a convention used elsewhere in the present specification). The identifier 1724 is generally associated with a particular property and/or an equity owner associated with the particular property. The identifier 1724, and/or other identifiers referred to hereafter, may comprise any suitable alphanumeric identifier, and the like.

Similar to as previously described, the identifier 1724 may be the same, or different, as an identifier received from one or more of the computing devices 1708, 1710. When the identifier 1724 is different from the identifier received from one or more of the computing devices 1708, 1710, the computing device 1702 may store a relationship between such an identifier and the identifier 1724 such that the identifier received from one or more of the computing devices 1708, 1710 is also associated with the equity indicator 1722 and/or a particular property. Regardless, the identifier received from one or more of the computing devices 1708, 1710, and/or the identifier 1724, is understood to identify the associated equity indicator 1722 as stored at the memory 1704, and/or the portion 1720, and is further understood to be associated with a particular property for which the associated equity indicator 1722 represents a pledge.

Hence, the identifier 1724 is further understood to be generally associated with a particular property (e.g. as is the identifier received from one or more of the computing devices 1708, 1710), and further the associated equity indicator 1722 is understood to be indicative of the pledge made by an equity owner towards the particular property. For example, with further reference to the examples described with respect to FIG. 2A, FIG. 16A and FIG. 16B, the equity indicator 1722 may initially indicate that a pledge of $25,000 has been made by an equity owner towards a property associated with the identifier 1724.

As will be described hereafter, the computing device 1702 may convert a first fungible amount of a first type (an indication of which is received from one or more of the computing devices 1708, 1710) into a second fungible amount of a second type, different from the first type, the second type associated with property value. The computing device 1702 may identify the equity indicator 1722 associated with the identifier received with the indication, and cause the equity indicator 1722 to change (e.g. increase) by an amount related to the second fungible amount of the second type. For example, the second fungible amount of the second type may be a currency-type, and the amount related to the second fungible amount of the second type may be a percentage of an equity value of the particular property (e.g. which may change with time). Alternatively, the second fungible amount of the second type may be a percentage of an equity value of the particular property (e.g. amount related to the second fungible amount of the second type may be the same as the second fungible amount).

In particular, the computing device 1702 may increase the equity indicator 1722 by the amount related to the second fungible amount of the second type, and, in response, change a periodic payment request for the particular property, relative to a previous payment request, to indicate the change to the equity indicator 1722.

In some examples, prior to increasing the equity indicator 1722 by the amount related to the second fungible amount of the second type, the amount related to the second fungible amount of the second type may be reduced, by the computing device 1702, by a quantity that is related to a service fee and/or processing fee. In these examples, the computing device 1702 may communicate with one or more of the computing devices 1708, 1710, and/or one or more of the financial institutions, to redeem such a service fee and/or processing fee, and/or credit such a service fee and/or processing fee to an associated account; such an associated account may include, but is not limited to, a digital wallet (e.g. managed by the computing device 1702), and/or an account of a financial institution 104.

Furthermore, it is understood that changes to the equity indicator 1722 result in physical changes to the portion 1720, for example as sectors are updated to reflect changes to the equity indicator 1722. As such, changes to the equity indicator 1722 result in physical changes to the memory 1704. Put another way, a transaction at the terminal 1706 generally results in physical changes to the memory 1704.

The term periodic payment request for a particular property, as used herein, may be a request for an amount that the equity owner pays each month (e.g. and/or any other suitable time period) to occupy the particular property. Furthermore, the periodic payment request may indicate that the amount that the equity owner pays each month has been reduced according to an increase in the equity indicator 1722. As such, the periodic payment request may be determined in a similar manner as described above with respect to FIG. 15, FIG. 16A and/or FIG. 16B.

Furthermore, the equity indicator 1722, and changes thereto, may be stored in a using blockchain technology, as described above. Hence, in some examples, the second fungible amount of the second type, and/or the amount related to the second fungible amount of the second type, may comprise blockchain tokens and/or fungible blockchain type tokens.

In this manner, points “earned” by use of transactions at the terminal 1706 may be converted into equity of a particular property, for example, without excessive exchanges of messages and/or without printing documents, and the like, and which may result in a reduction of a periodic payment amount by a payment reduction benefit that is determined by an increase in equity.

Further components of the system 1700 are next described.

For example, as depicted, the system 1700 further comprises a communication device 1726 that may be operated by, and/or associated with, the equity owner associated with the equity indicator 1722 and/or the identifier 1724. Indeed, in some examples, rather than a card, the communication device 1726 may be used to interact with the terminal 1706, as described above using NRC. The computing device 1702 may provide (e.g. transmit) the periodic payment request, as changed, to the communication device 1726 to provide an indication of the change. Alternatively, the computing device 1702 may provide (e.g. transmit) to the communication device 1726 a message indicating the change to the equity indicator 1722. The communication device 1726 may comprise a consumer device 102 of the system 100.

As further depicted in FIG. 17, the system 1700 may further comprise another terminal (e.g. a point-of-sale terminal) and/or a further communication device 1728, which may be similar to the terminal 1706 and/or the further communication device 1726, and which may also be used to provide, to the computing device 1702, an indication of: a first fungible amount of a first type; and a particular property. As will be described below, the terminal and/or communication device 1728 may be used to transfer a first fungible amount of a first type to an equity owner, for example in exchange for goods and/or services provided by the equity owner, and the like, and which may be converted into a second fungible amount of a second type associated with property value, and used to change the equity indicator 1722.

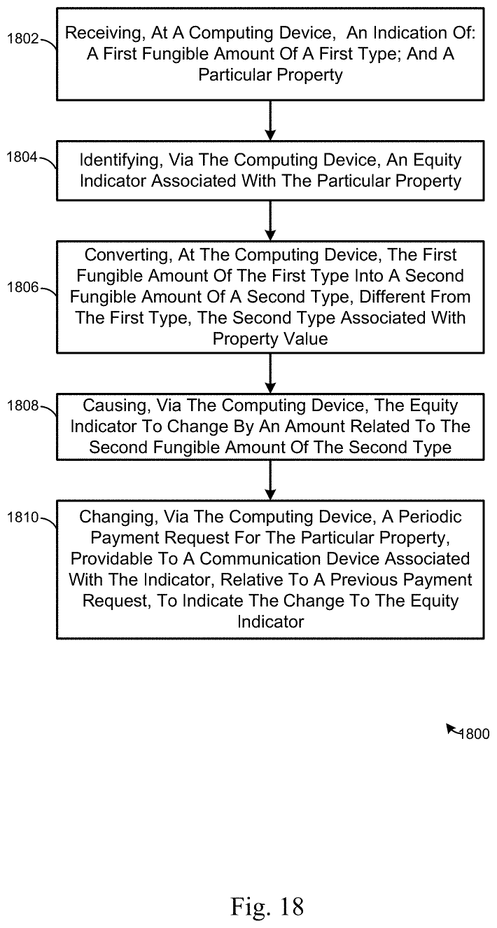

Attention is now directed to FIG. 18, which depicts a flowchart representative of a method 1800 for changing periodic payment requests for particular properties relative to previous payment requests. The operations of the method 1800 of FIG. 18 correspond to machine readable instructions that are executed by the computing device 1702, and specifically the controller 1712 of the computing device 1702. In the illustrated example, the instructions represented by the blocks of FIG. 18 are stored at the memory 1714 for example, as the application 1716. The method 1800 of FIG. 18 is one way that the controller 1712 and/or the computing device 1702 and/or the system 100 may be configured. Furthermore, the following discussion of the method 1800 of FIG. 18 will lead to a further understanding of the system 100, and its various components.

The method 1800 of FIG. 18 need not be performed in the exact sequence as shown and likewise various blocks may be performed in parallel rather than in sequence. Accordingly, the elements of method 1800 are referred to herein as “blocks” rather than “steps.” The method 1800 of FIG. 18 may be implemented on variations of the system 100 of FIG. 1, as well.

At a block 1802, the computing device 1702 and/or the controller 1712 receives, (e.g. via the communication interface 1718), an indication of: a first fungible amount of a first type; and a particular property.

As described above, the computing device 1702 and/or the controller 1712 may receive such an indication from one or more of the computing devices 1708, 1710. In some examples, the computing devices 1708, 1710 may be to accumulate and/or assign value to points, and hence, in such examples, the first fungible amount of the first type may be received from one or more of a points accumulator computing device and a points intermediator computing device.

Alternatively, the computing device 1702 and/or the controller 1712 may receive such an indication from the terminal 1706.

Furthermore, the first fungible amount of the first type may be generated based on activities not initially associated with the computing device 1702. For example, transactions of goods and services that may occur via the terminal 1706 may not be associated with the computing device 1702, at least until the terminal 1706 provides associated information to one or more of the computing devices 1708, 1710 and/or the indication is received at the computing device 1702.

In some examples, as has already been described, the first fungible amount of the first type may be representative of points provided in exchange for purchase of one or more of goods and services external to the computing device 1702. Furthermore, as has already been described, the first fungible amount of the first type may be representative of the points converted into a currency-type amount, such as a value and/or a market-value of the points that is determined by one or more of the computing devices 1708, 1710 (e.g. the intermediator computing device 1710). Alternatively, the computing device 1702 may be adapted for functionality of the intermediator computing device 1710 such that the method 1800 may further comprise further comprise, the computing device 1702 and/or the controller 1712, converting the first fungible amount from a points-type amount to a currency-type amount.

Furthermore, the indication of the particular property may include, but is not limited to, the identifier 1724 and/or any suitable identifier and/or any other suitable indication of the particular property.

At a block 1804, the computing device 1702 and/or the controller 1712 identifies the equity indicator 1722 associated with the particular property indicated at the block 1802. For example, as has already been described, an identifier may be received at the block 1802, which may comprise the identifier 1724, or may be associated with the identifier 1724, and hence, the computing device 1702 and/or the controller 1712 may identify the equity indicator 1722, associated with any suitable identifier received at the block 1802, via a relationship with the identifier 1724.

At a block 1806, the computing device 1702 and/or the controller 1712 converts the first fungible amount of the first type into a second fungible amount of a second type, different from the first type, the second type associated with property value, for example a property value associated with the particular property for which the equity indicator 1722 represents a pledge.

In some examples, the computing device 1702 and/or the controller 1712 may determine a value of the particular property for which the equity indicator 1722 represents a pledge, via the suite value module 700.

Furthermore, the second fungible amount of the second type may represent a portion and/or percentage, and the like, of the particular property for which the equity indicator 1722 represents a pledge. Hence, for example, the second fungible amount of the second type may be in a same format as the equity indicator 1722 and/or a percentage of equity of the associated particular property, and the like.

Hence, in some examples, regardless of a format of the first fungible amount of the first type, the first fungible amount may generally represent points provided in exchange for purchase of one or more of goods and services external to the computing device 1702, and the second fungible amount of the second type is understood to be representative of property value. As such, in these examples, the computing device 1702 and/or the controller 1712 may convert fungible amounts representative of points to fungible amounts representative of property value.

At a block 1808, the computing device 1702 and/or the controller 1712 causes the equity indicator 1722 to change by an amount related to the second fungible amount of the second type. For example, the computing device 1702 and/or the controller 1712 may generally cause the equity indicator 1722 to increase to show additional equity pledged by the equity owner towards the associated particular property. In some examples, the amount by which the equity indicator 1722 is changed is the same as the second fungible amount of the second type; however, in other examples, the amount by which the equity indicator 1722 is changed may be in a different form from the second fungible amount of the second type; for example, the second fungible amount of the second type may be a percentage of equity, while the amount by which the equity indicator 1722 is changed may be in a-type format (though representative of a same increase in property value indicated by the second fungible amount of the second type).

At a block 1810, the computing device 1702 and/or the controller 1712 changes a periodic payment request for the particular property, providable to a communication device, such as the communication device 1726, associated with the indicator received at the block 1802 (and the like), relative to a previous payment request, to indicate the change to the equity indicator 1722. For example, a changed periodic payment request may indicate a lower monthly payment for the particular property than a previous payment request as the equity indicator 1722 increases. Put another way, with reference to the examples of FIG. 15, FIG. 16A and FIG. 16B, a consumer's payment reduction benefit may increase as the equity indicator 1722 increases, which reduces monthly payment for the particular property relative to a previous monthly payment.

For example, it is understood that the communication device 1726 may also be associated with the identifier 1724, and hence the communication device 1726 may also be associated with the indication of the particular property (and the like) received at the block 1802. Regardless, the computing device 1702 and/or the controller 1712 are understood to be further configured to communicate with the communication device 1726 via any suitable messaging, such as text, email, and the like, and/or via an “app” (e.g. application) being implemented at the communication device 1726.

Hence, in some examples, the method 1800 may further comprise the computing device 1702 and/or the controller 1712 providing, to the communication device 1726 associated with the indication of the particular property (and the like) received at the block 1802 (and the like), the periodic payment request as changed (e.g. via a message and/or an “app”, and the like).

Regardless, when the equity indicator 1722 changes, a periodic payment request may change, relative to a previous periodic payment request that represented an initial equity of an equity owner in the particular property, prior to the equity indicator 1722 changing.

Furthermore, the periodic payment request may indicate that the amount that the equity owner pays each month has been reduced according to an increase in the equity indicator 1722. As such, the periodic payment request may be determined in a similar manner as described above with respect to FIG. 15, FIG. 16A and/or FIG. 16B. Put another way, the periodic payment request may comprise a request for a monthly (and/or periodic) payment on the particular property which may be reduced relative to previous monthly (and/or periodic) payment.

In some examples, the method 1800 may further comprise the computing device 1702 and/or the controller 1712 providing, to the communication device 1726 associated with the indication of the particular property (and the like) (e.g. received at the block 1802), a message indicating the change to the equity indicator 1722. Put another way, in response to the equity indicator 1722 changing at the block 1808, the computing device 1702 and/or the controller 1712 may notify the communication device 1726 of such a change via any suitable message and/or application (e.g. “app”) and the like.

Hence, it is understood that in place of the block 1810 and/or in addition to the block 1810, and/or in conjunction with the block 1810, the computing device 1702 and/or the controller 1712 causes an action, and/or an electronic action, associated with an electronic computing device, for example via the communication interface 1718, for example, to providing, to the communication device 1726, the periodic payment request and/or the message indicating the change to the equity indicator 1722, which processes the periodic payment request and/or the message. Alternatively, such an action and/or electronic action may include transmitting a notification of the equity indicator 1722 changing to one or more of the computing devices 1708, 1710 to cause one or more of the computing devices 1708, 1710 to implement an action, and/or an electronic action, of processing the notification. In other words, actions caused by the computing device 1702 and/or the controller 1712 are understood to cause devices to comprise electronic actions. Indeed, hereafter, references to an action, or actions, are understood to comprise an electronic action, or electronic actions.

In some examples, the method 1800 may be adapted such that the first fungible amount of the first type is received, at the block 1802, from one or more of a point-of-sale terminal and a further communication device, such as the terminal (e.g. a point-of-sale terminal) and/or further communication device 1728. For simplicity, hereafter, the terminal and/or further communication device 1728 is referred to as the further communication device 1728.

For example, the further communication device 1728 may be operating an application (e.g. an “app”) which may be used to pay for goods and/or services that may be associated with one or more of the equity owner associated with the equity indicator 1722 and/or the identifier 1724, and/or the communication device 1726, and the like. In a simple example, the equity owner associated with the equity indicator 1722, and the like, may offer to sell an item, or a service to an operator of the further communication device 1728. The operator of the further communication device 1728 may pay for the goods and/or service by operating the further communication device 1728 to enter an identifier (e.g. hereafter the identifier 1724) of the equity owner associated with the equity indicator 1722 and an amount to be paid for the goods and/or service. In some examples, the identifier 1724 may be received via the communication devices 1726, 1728 exchanging information which includes, but is not limited to, the identifier 1724 being transmitted from the communication device 1726 to the communication device 1728, for example via a near-field communication exchange of information. Alternatively, the identifier 1724 may be verbally provided by the equity owner to the operator of the further communication device 1728, who may operate an input device (e.g. a keyboard, and the like) of the further communication device 1728 to enter the identifier 1724 into the further communication device 1728, and/or the equity owner operate the input device of the further communication device 1728 to enter the identifier 1724 into the further communication device 1728 (e.g. presuming the equity owner and the operator of the further communication device 1728 are co-located).

Alternatively, an application at the further communication device 1728 may provide a directory of equity owners (e.g. provided by the computing device 1702) and an operator of the further communication device 1728 may select the equity owner (e.g. a name and/or identifier thereof, and the like) from the directory.

Regardless, the computing device 1702 may receive, at the block 1802, the indication (e.g. of a first fungible amount of a first type, and an identifier associated with a particular property) from the further communication device 1728. In these examples, the first fungible amount of a first type may be a currency-type, and, and the block 1806, the computing device 1702 may convert the currency-type fungible amount into a second fungible amount of a second type associated with property value, as described above. The method 1800 may otherwise proceed as previously described.

Hence, in these examples, an equity owner of a particular property may offer goods and/or a service, and the like, in exchange for an increase in an equity indicator (e.g. the equity indicator 1722), that is initiated by the operator of the further communication device 1728. The further communication device 1728 may further communicate with a financial institution 104, and/or with digital wallets thereof, to debit the first fungible amount of a first type from an associated account and credit the first fungible amount of a first type to an account associated with the computing device 1702.

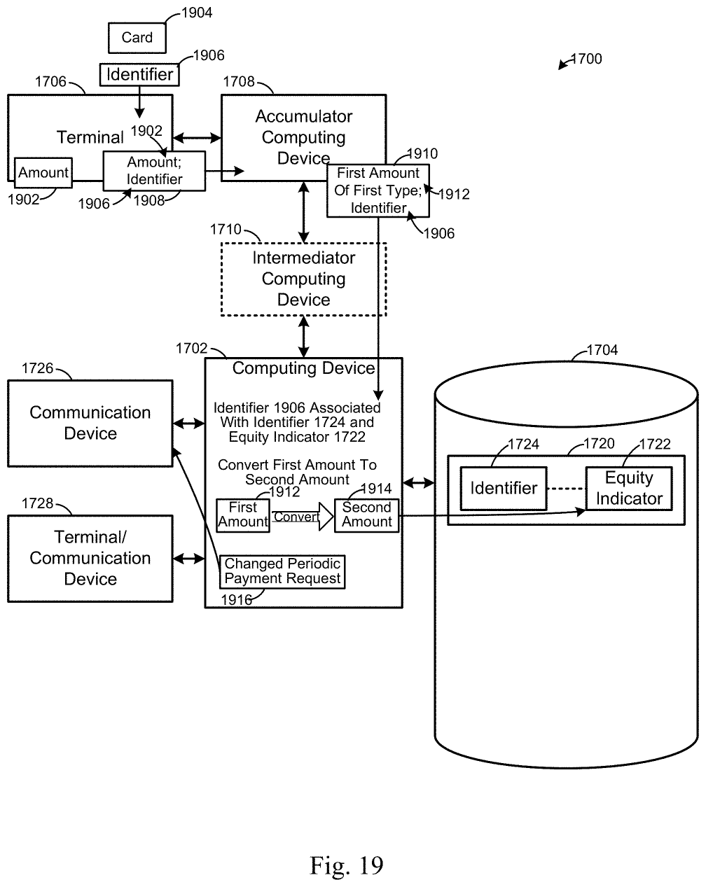

Attention is next directed to FIG. 19 which depicts an example of aspects of the method 1800. FIG. 19 is substantially similar to FIG. 17, with like components having like numbers. While components of the computing device 1702 are not depicted, they are nonetheless understood to be present.

Starting at the terminal 1706, a transaction of an amount 1902 (e.g. a currency-type amount) occurs, and a card 1904 is presented to the terminal 1706, which reads an identifier 1906 from the card 1904. The card 1904 may be presented by the equity owner associated with the equity indicator 1722 and the identifier 1906 may comprise a loyalty points identifier, and the like.

While not depicted, it is understood that the transaction may be completed by communication with the financial institutions 104 (e.g. to debit an account of the equity owner and credit an account of the retail store, and the like, associated with the terminal 1706), and/or with digital wallets thereof. In response, the terminal 1706 transmits a message 1908 to the accumulator computing device 1708, the message 1908 including the amount 1902 and the identifier 1906. The accumulator computing device 1708 is understood to convert the amount 1902 to a first fungible amount 1912 of a first type (e.g. loyalty points), and transmits an indication 1910 (e.g. in the form of a message) to the computing device 1702 (e.g. via the intermediator computing device 1710) that includes the first fungible amount 1912 of the first type, and the identifier 1906.

The computing device 1702 receives (e.g. at the block 1802 of the method 1800), the indication 1910, and uses an association between the identifier 1906 and the identifier 1724 (not depicted) to identify (e.g. at the block 1804 of the method 1800) the equity indicator 1722. Such an identification of the equity indicator 1722 may occur via a database lookup, and the like, at the memory 1704.

The computing device 1702 further converts (e.g. at the block 1806 of the method 1800) the first fungible amount 1912 of the first type to a second fungible amount 1914 of a second type and applies the second fungible amount 1914 to the equity indicator 1722, causing (e.g. at the block 1808 of the method 1800) the equity indicator 1722 to increase. As such, the equity owner's pledge for a particular property is understood to increase. The computing device 1702 changes (e.g. at the block 1810 of the method 1800) a periodic payment request 1916 to indicate the change to the equity indicator 1722. As depicted, the periodic payment request 1916 is provided to the communication device 1726.

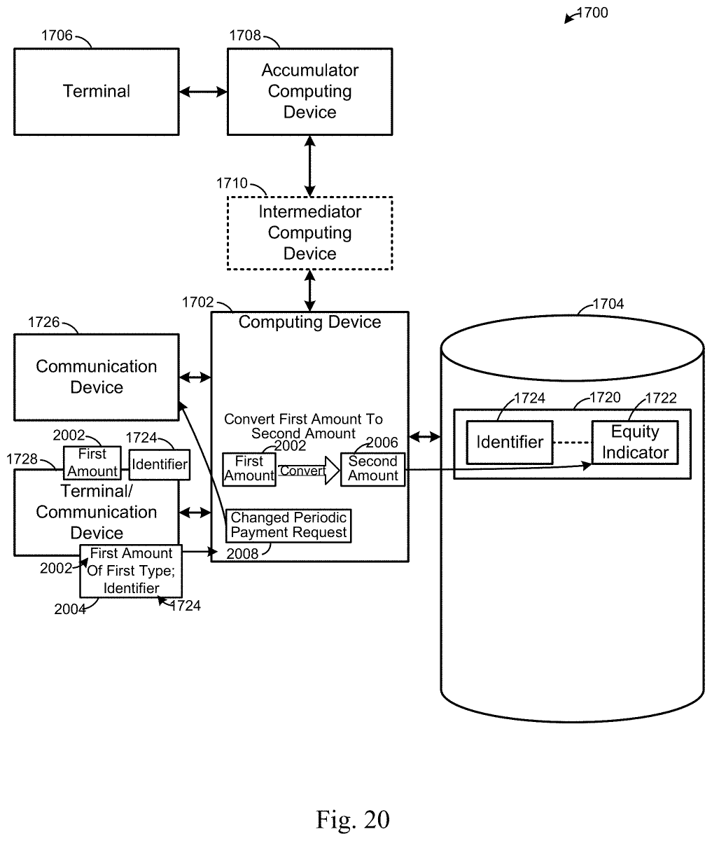

Attention is next directed to FIG. 20 which depicts an example of other aspects of the method 1800. FIG. 20 is substantially similar to FIG. 17, with like components having like numbers.

Starting at the further communication device 1728, a first fungible amount 2002 of a first type is received (e.g. via an input device), along with the identifier 1724. The further communication device 1728 transmits an indication 2004 (e.g. in the form of a message) to the computing device 1702, the indication 2004 including the first fungible amount 2002 and the identifier 1724. While not depicted, it is understood that the first fungible amount 2002 may be debited from an account associated with a user associated with the further communication device 1728 via communication with one or more of the financial institutions 104, and/or with digital wallets thereof

The computing device 1702 receives (e.g. at the block 1802 of the method 1800), the indication 2004, and identifies (e.g. at the block 1804 of the method 1800) the equity indicator 1722 from the identifier 1724. Such an identification of the equity indicator 1722 may occur via a database lookup, and the like, at the memory 1704.

The computing device 1702 further converts (e.g. at the block 1806 of the method 1800) the first fungible amount 2002 of the first type to a second fungible amount 2006 of a second type and applies the second fungible amount 2006 to the equity indicator 1722, causing (e.g. at the block 1808 of the method 1800) the equity indicator 1722 to increase. As such, the equity owner's pledge for a particular property is understood to increase. The computing device 1702 changes (e.g. at the block 1810 of the method 1800) a periodic payment request 2008 to indicate the change to the equity indicator 1722. As depicted, the periodic payment request 2008 is provided to the communication device 1726.

In other examples, the first fungible amount 2002 (and/or a portion thereof) may be provided in the form of points, and the example of FIG. 20 may be modified such that the further communication device 1728, and/or the computing device 1702, communicates with an associated suitable points accumulator computing device and/or an associated suitable points intermediator computing device (e.g., which may include, but is not limited to, the computing devices 1708, 1710) to determine a value for the points to convert the first fungible amount 2002 (and/or the portion thereof) to the second fungible amount 2006, with associated debiting of a points account associated with the further communication device 1728.

Further features are within the scope of the present specification.

For example, the method 1800 may be modified such that an indication (received at the block 1802 at the computing device 1702) identifies a plurality of particular properties, and the second fungible amount of the second type (e.g. determined at the block 1806) may be divided between a plurality of equity indicators respectively associated with the plurality of particular properties.

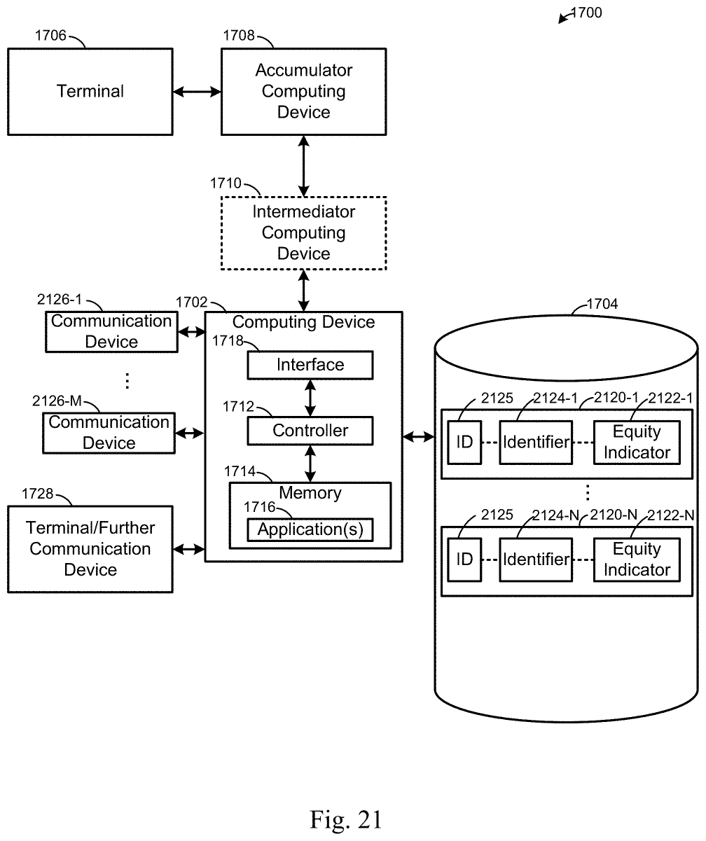

For example, attention is next directed to FIG. 21 which depicts the system 1700 with the memory 1704, at a plurality of portions 2120-1 . . . 2120-N, storing an “N” number of plurality of equity indicators 2122-1 . . . 2122-N in association with a plurality of respective identifiers 2124-1 . . . 2124-N. The plurality of portions 2120-1 . . . 2120-N are interchangeably referred to hereafter, collectively, as the portions 2120 and, generically, as a portion 2120. This convention will be used hereafter. For example, the plurality of equity indicators 2122-1 . . . 2122-N may be referred to hereafter as the equity indicators 2122 and/or as an equity indicator 2122. Similarly, the plurality of respective identifiers 2124-1 . . . 2124-N may be referred to hereafter as the identifiers 2124 and/or as an identifier 2124.

The portions 2120, the equity indicators 2122, and the identifiers 2124 may be similar, respectively, to the portion 1720, the equity indicator 1722, and the identifier 1724. However, the equity indicators 2122 may be associated with a plurality of equity owners (e.g. on a one-to-one basis though one equity owner may be associated with more than equity indicator 2122 and/or particular property) and represent respective pledges to a plurality of properties (e.g. suites in a particular building and/or at a Property P1, Property P2, etc., of the system 100). The identifiers 2124 are understood to comprise any suitable identifiers identifying respective equity owners and/or particular properties. In examples described hereafter, it is understood that the equity indicators 2122, and the identifiers 2124 may be associated with particular properties at one building and/or development (and/or LPMS 103). As such, the equity indicators 2122 and/or the identifiers 2124 may be further associated with identifier 2125 which identifies the particular properties and/or is associated with the particular properties. For example, the identifier 2125 may comprise any suitable alphanumeric identifier of a building and/or development (and/or LPMS 103) at which the particular properties are located.

Hence, the number “N” of the equity indicators 2122 and the identifiers 2124 may be any suitable number of the particular properties at the one building and/or development for which equity owners have provided pledges.

It is further understood, hereafter, that the equity owners at the one building and/or development may provide goods and/or services to non-equity owners, such as members of the general public in exchange for fungible amounts of a first type. In a particular example, the equity owners at the one building and/or development may make a swimming pool, a gym, a meeting room, and the like, available for use by the general public in exchange for fungible amounts of a first type.

Also depicted in FIG. 21 are a plurality of communication devices 2126-1 . . . 2126-M (e.g. communication devices 2126 and/or a communication device 2126). One communication device 2126 may comprise the communication device 1726; hence, while not depicted, the communication device 1726 may be present in the form of one of the communication devices 2126.

The communication devices 2126 are understood to be operated by, and/or associated with, the equity owners associated with the equity indicators 2122. The number “M” of the communication devices 2126 may be a same number “N” of the equity indicators 2122, or the number “M” of the communication devices 2126 may be less than the number “N” of the equity indicators 2122 (e.g. when one equity owner is associated with more than one equity indicator 2122, for example when one equity owner has made pledges on more than one particular property).

The terminal and/or further communication device 1728 may be used to accept fungible amounts of a first type in exchange for the goods and/or services provided by the equity owners, and may comprise one of the communication devices 2126 (e.g. operating a payment “app”) and/or the further communication device 1728 may be operated by an employee of the building and/or development to accept fungible amounts of a first type. For example, when a member of the general public pays to enter a swimming pool, the further communication device 1728 may be used to process such a transaction.

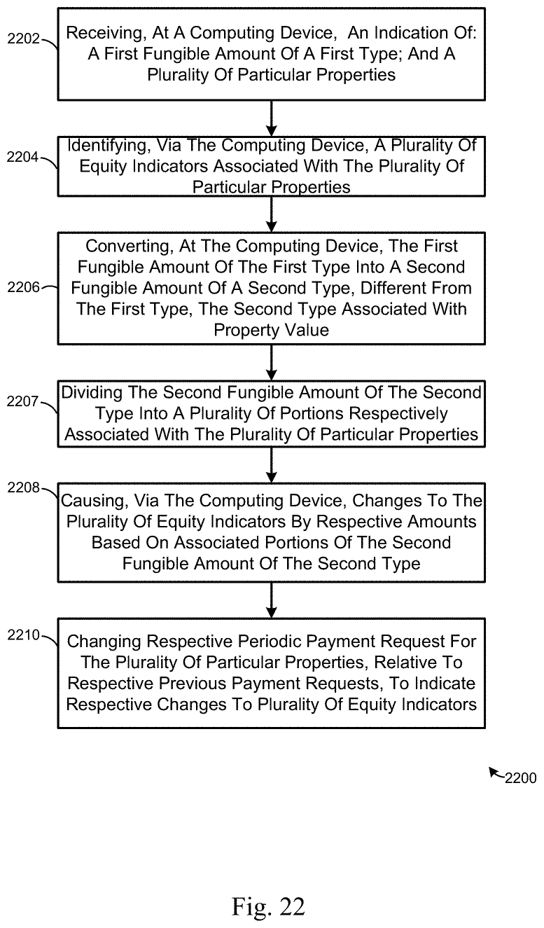

Attention is now directed to FIG. 22, which depicts a flowchart representative of a method 2200 for changing periodic payment requests for particular properties relative to previous payment requests adapted for a plurality of equity indicators. The operations of the method 2200 of FIG. 22 correspond to machine readable instructions that are executed by the computing device 1702, and specifically the controller 1712 of the computing device 1702. In the illustrated example, the instructions represented by the blocks of FIG. 22 are stored at the memory 1714 for example, as the application 1716 and/or a module of the application 1716 adapted for a plurality of equity indicators. The method 2200 of FIG. 22 is one way that the controller 1712 and/or the computing device 1702 and/or the system 100 may be configured. Furthermore, the following discussion of the method 2200 of FIG. 22 will lead to a further understanding of the system 100, and its various components.

The method 2200 of FIG. 22 need not be performed in the exact sequence as shown and likewise various blocks may be performed in parallel rather than in sequence. Accordingly, the elements of method 2200 are referred to herein as “blocks” rather than “steps.” The method 2200 of FIG. 22 may be implemented on variations of the system 100 of FIG. 1, as well.

It is furthermore understood that the method 2200 is substantially similar to the method 1800, but adapted for a plurality of equity indicators, with like blocks having like numbers, but in a “2200” series rather than “1800” series.

At a block 2202, the computing device 1702 and/or the controller 1712 receives an indication of: a first fungible amount of a first type; and a plurality of particular properties. The indication may comprise the identifier 2125 to indicate and/or identify the plurality of particular properties. Hence, the block 2202 is similar to the block 1802 of the method 1800, except that the indication received is associated with a plurality of particular properties. For simplicity, it is assumed hereafter that the indication received at the block 2202 comprises the identifier 2125. Furthermore, the first fungible amount of a first type may, in these examples, comprise a currency-type amount. However, in other examples, a member of the general public may pay with points, similar to as described above with respect to FIG. 20, such that the first fungible amount of the first type may comprise points-type amount.

At a block 2204, the computing device 1702 and/or the controller 1712 identifies the plurality of equity indicators 2122 associated with the identifier 2125, similar to as described above with respect to the block 1802.

At a block 2206, the computing device 1702 and/or the controller 1712 converts the first fungible amount of the first type into a second fungible amount of a second type, different from the first type, the second type associated with property value. Hence, the block 2204 is similar to as described above with respect to the block 1804.

At a block 2207, the computing device 1702 and/or the controller 1712 divides the second fungible amount of the second type into a plurality of portions respectively associated with the plurality of particular properties.

In some examples, the second fungible amount may be divided equally between the plurality of particular properties such that the plurality of particular properties is divided by the number “N”, and each portion is equal to the second fungible amount divided by “N”.

In other examples, the second fungible amount may be divided between the plurality of particular properties based on respective payment benefit coefficients (e.g. p as described above with reference to FIG. 15, FIG. 16A and FIG. 16B) of the equity indicator 2122, and the like. Put another way, a portion of the second fungible amount, associated with a respective particular property, may be dependent on a size of an existing pledge against the respective particular property relative to the value of the respective particular property. Hence, in such examples, current values of the particular properties may be determined by the computing device 1702 and/or the controller 1712 via the suite value module 700. In some examples, the computing device 1702 and/or the controller 1712 may determine relative sizes of the respective payment benefit coefficients, associated with the plurality of particular properties and/or the equity owners, and divide the second fungible amount of the second type into the plurality of portions accordingly, such that equity owners having higher respective payment benefit coefficients, relative to other equity owners, are provided larger portions of the second fungible amount. Put another way, the respective payment benefit coefficients may be used as weights, and/or in any suitable weighting scheme, to determine relative sizes of the particular portions.

At a block 2208, the computing device 1702 and/or the controller 1712 causes respective changes to the plurality of equity indicators by respective amounts based on associated portions of the second fungible amount of the second type.

The respective amounts may be determined in a manner similar to as described with respect to the block 1808. Furthermore, it is understood that, at the second fungible amount of the second type block 2206 and/or the block 2207 and/or the block 2208, reductions to the second fungible amount of the second type and/or the portions thereof may occur, for example, to pay for a cost of operating a service, such as a swimming pool, and/or such reductions may be for a service fee and/or processing fee.

Furthermore, it is understood that changes to the equity indicators 2122 result in physical changes to respective portions 2120, for example as respective sectors are updated to reflect changes to the equity indicators 2122. As such, changes to the equity indicators 2122 result in physical changes to the memory 1704.

At a block 2210, the computing device 1702 and/or the controller 1712 changes respective periodic payment requests for the plurality of particular properties, relative to respective previous payment requests, to indicate respective changes to the plurality of equity indicators 2122. The block 2210 is generally similar to the block 1810 of the method 1800, other than that a plurality of periodic payment requests are changed rather than one periodic payment request.

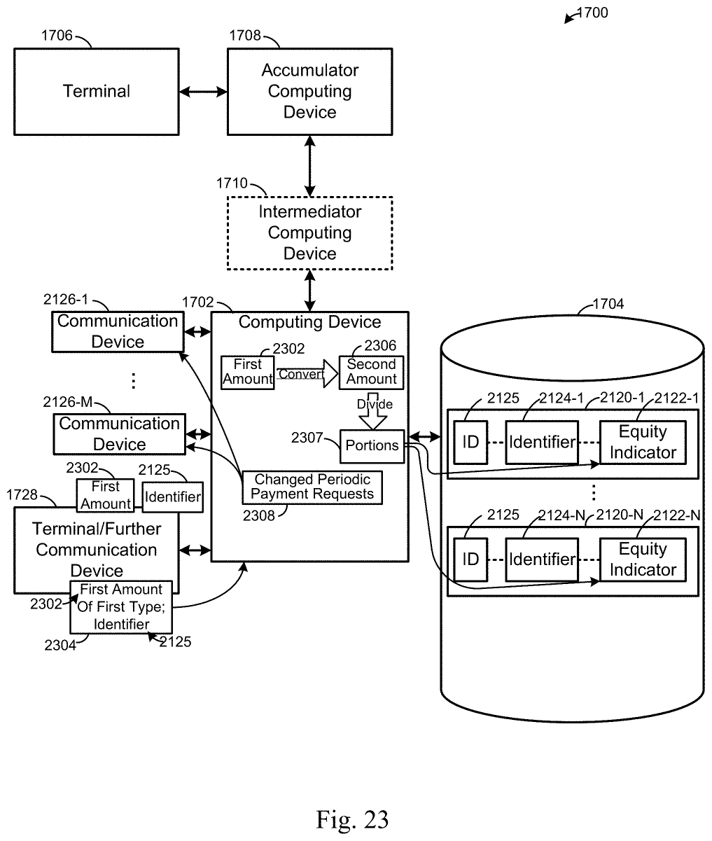

Attention is next directed to FIG. 23 which depicts an example of aspects of the method 2200. FIG. 23 is substantially similar to FIG. 21, with like components having like numbers. While components of the computing device 1702 are not depicted, they are nonetheless understood to be present.

Starting at the further communication device 1728, a first fungible amount 2302 of a first type is received (e.g. via an input device), along with the identifier 2125. The further communication device 1728 transmits an indicator 2304 (e.g. in the form of a message) to the computing device 1702, the indicator 2304 including the first fungible amount 2302 and the identifier 2125. While not depicted, it is understood that the first fungible amount 2302 may comprise one or more amounts that are debited from accounts from one or more users that have paid for goods and/or services using the further communication device 1728 via communication with one or more of the financial institutions 104 and/or with digital wallets thereof; alternatively, the first fungible amount 2302 may represent a plurality of payments (e.g. a total thereof) that may occur using other devices.

The computing device 1702 receives (e.g. at the block 2202 of the method 2200), the indicator 2304, and identifies (e.g. at the block 2204 of the method 2200) the equity indicators 2122 from the identifier 2125. Such an identification of the equity indicators 2122 may occur via a database lookup, and the like, at the memory 1704.

The computing device 1702 further converts (e.g. at the block 2206 of the method 2200) the first fungible amount 2302 of the first type to a second fungible amount 2306 of a second type, as has been previously described. In such examples, the second fungible amount 2306 of a second type may be based on a total value of the plurality of particular properties. The computing device 1702 further divides (e.g. at the block 2207 of the method 2200) the second fungible amount 2306 into portions 2307 (e.g. at the block 2207 of the method 2200), and applies the portions 2307 to respective equity indicators 2122, causing (e.g. at the block 2208 of the method 2200) the equity indicators 2122 to increase. As such, the various equity owner's pledges for particular properties are understood to respectively increase. The computing device 1702 changes (e.g. at the block 2210 of the method 2200) periodic payment requests 2308 to indicate the change to the equity indicators 2122. As depicted, the periodic payment request 2308 are provided to respective communication devices 2126.

In other examples, the first fungible amount 2302 (and/or a portion thereof) may be provided in the form of points, and the example of FIG. 23 may be modified such that the further communication device 1728, and/or the computing device 1702, communicates with one or more associated suitable points accumulator computing devices and/or one or more associated suitable points intermediator computing device (e.g., which may include, but not limited to, the computing devices 1708, 1710) to determine a value for the points to convert the first fungible amount 2302 (and/or the portion thereof) to the second fungible amount 2306, with associated debiting of a points account(s) occurring accordingly.

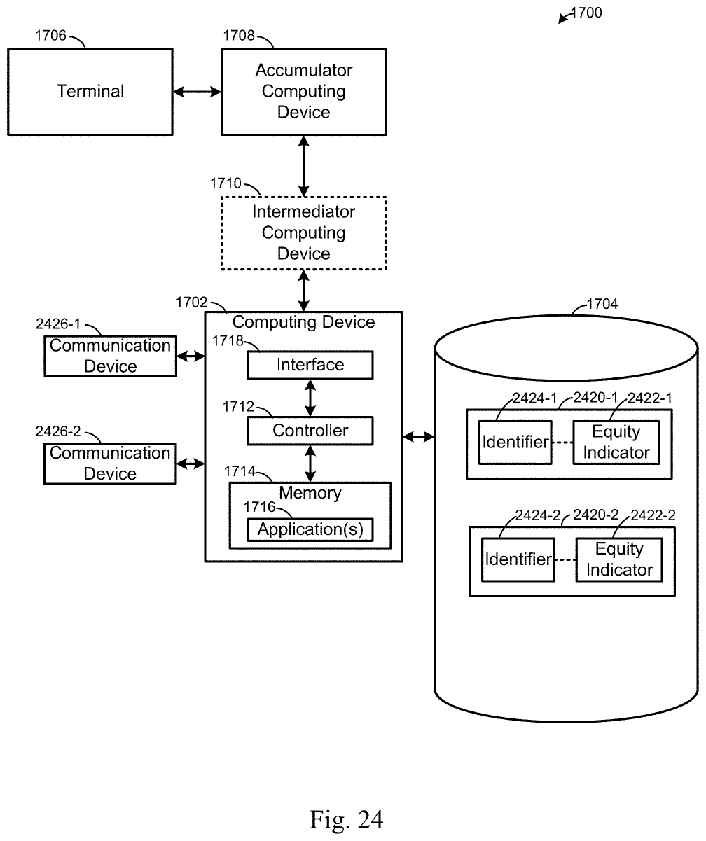

Attention is next directed to FIG. 24 which depicts the system 1700 adapted to exchange equity value between equity indicators. FIG. 24 is substantially similar to FIG. 17, with like components having like numbers.

FIG. 24 depicts the system 1700 with the memory 1704, at respective portions 2420-1, 2420-2 (e.g. portions 2420 and/or a portion 2420), respectively storing a first equity indicator 2422-1 and a second equity indicator 2422-2 (e.g. equity indictors 2422 and/or an equity indicator 2422) in association with a first identifier 2424-1 and a second identifier 2424-2 (e.g. identifiers 2424 and/or an identifier 2424). The first identifier 2424-1 is understood to be associated with a first particular property and a first equity owner that has a pledge on the first particular property, as represented by the first equity indicator 2422-1. Similarly, the second identifier 2424-2 is understood to be associated with a second particular property and a second equity owner that has a pledge on the second particular property, as represented by the second equity indicator 2422-2.

Hence, the portions 2420, the equity indicators 2422, and the identifiers 2424 may be similar, respectively, to the portion 1720, the equity indicator 1722, and the identifier 1724.

Also depicted in FIG. 24 are a first communication devices 2426-1 and a second communication device 2426-2 (e.g. communication devices 2426 and/or a communication device 2426). One communication device 2426 may comprise the communication device 1726 or the further communication device 1728; hence, while not depicted, the communication device 1726 and/or the further communication device 1728 may be present in the form of one of the communication devices 2426.

The first communication device 2426-1 is understood to be operated by, and/or associated with, the first equity owner associated with the equity indicator 2422 -1, and the second communication device 2426-2 is understood to be operated by, and/or associated with, the second equity owner associated with the equity indicator 2422 -2.

As will described hereafter, one of the equity owners may provide goods and/or services to the other of the equity. In a particular example, a first equity owner may wish to engage a second equity owner for a service (e.g. such as cleaning, and the like), and such a service may be offered via decreasing the first equity indicator 2422-1 associated with the first equity owner and increasing the second equity indicator 2422-2 associated with the second equity owner as is next described.

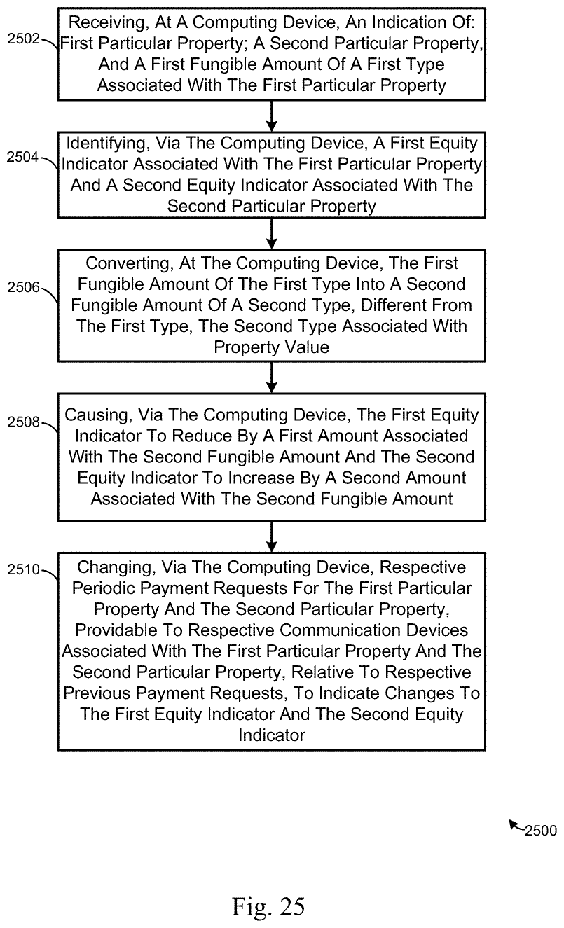

Attention is now directed to FIG. 25, which depicts a flowchart representative of a method 2500 for changing periodic payment requests for two particular properties. The operations of the method 2500 of FIG. 25 correspond to machine readable instructions that are executed by the computing device 1702, and specifically the controller 1712 of the computing device 1702. In the illustrated example, the instructions represented by the blocks of FIG. 25 are stored at the memory 1714 for example, as the application 1716 and/or a module of the application 1716 adapted for changing periodic payment requests for two particular properties. The method 2500 of FIG. 25 is one way that the controller 1712 and/or the computing device 1702 and/or the system 100 may be configured. Furthermore, the following discussion of the method 2500 of FIG. 25 will lead to a further understanding of the system 100, and its various components.

The method 2500 of FIG. 25 need not be performed in the exact sequence as shown and likewise various blocks may be performed in parallel rather than in sequence. Accordingly, the elements of method 2500 are referred to herein as “blocks” rather than “steps.” The method 2500 of FIG. 25 may be implemented on variations of the system 100 of FIG. 1, as well.

At a block 2502, the computing device 1702 and/or the controller 1712 receives an indication of: a first particular property; a second particular property, and a first fungible amount of a first type associated with the first particular property. For example, the indication may include the identifiers 2424 and may be received from the first communication device 2426-1 (e.g. associated with the first particular property).

At a block 2504, the computing device 1702 and/or the controller 1712 identifies the first equity indicator 2422-1 associated with the first particular property and a second equity indicator 2422-2 associated with the second particular property. Such an identification may be performed via a database lookup at the memory 1704 using the identifiers 2424 received at the block 2502, and/or in any other suitable manner. Furthermore, the first fungible amount may be a currency-type and/or a points-type amount, as previously described.

At a block 2506, the computing device 1702 and/or the controller 1712 converts the first fungible amount of the first type into a second fungible amount of a second type, different from the first type, the second type associated with property value. The second fungible amount may be related to the property values of the first property and the second property (e.g. percentages of equity thereof, and the like). In some examples, such conversion may further include currency conversion.

At a block 2508, the computing device 1702 and/or the controller 1712 causes the first equity indicator 2422-1 to reduce by a first amount associated with the second fungible amount and the second equity indicator 2422-2 to increase by a second amount associated with the second fungible amount. The first and second amounts may be the same, or the first and second amounts may be different. For example, the second amount may comprise the first amount with a service fee, and the like, deducted therefrom.

Regardless, a portion of a pledge represented by the first equity indicator 2422-1 is transferred to the second equity indicator 2422-2 to pay for goods and/or a service that the second equity owner provides to the first equity owner.

Accordingly, respective periodic payment requests are updated.

For example, at a block 2510, the computing device 1702 and/or the controller 1712 causes changes respective periodic payment requests for the first particular property and the second particular property, providable to respective communication devices 2426-1, 2426-2 associated with the first particular property and the second particular property, relative to respective previous payment requests, to indicate changes to the first equity indicator 2422-1 and the second equity indicator 2422-2.

Similar to the method 1800, the method 2500 may further include the computing device 1702 and/or the controller 1712 providing, to the respective communication devices 2426, respective messages indicating respective changes to the first equity indicator 2422-1 and the second equity indicator 2422-2. Similar to the method 1800, the method 2500 may further include the computing device 1702 and/or the controller 1712 providing, to the respective communication devices 2426, the respective periodic payment requests as changed.

Hence, similar to the method 1800, it is understood that in place of the block 2510 and/or in addition to the block 2510, and/or in conjunction with the block 18102510 the computing device 1702 and/or the controller 1712 causes an action, and/or electronic actions, associated with an electronic computing device, for example via the communication interface 1718, for example, to providing, to the communication devices 2426, the periodic payment requests and/or the messages indicating the change to the equity indicator 1722, which processes the periodic payment requests and/or the messages.

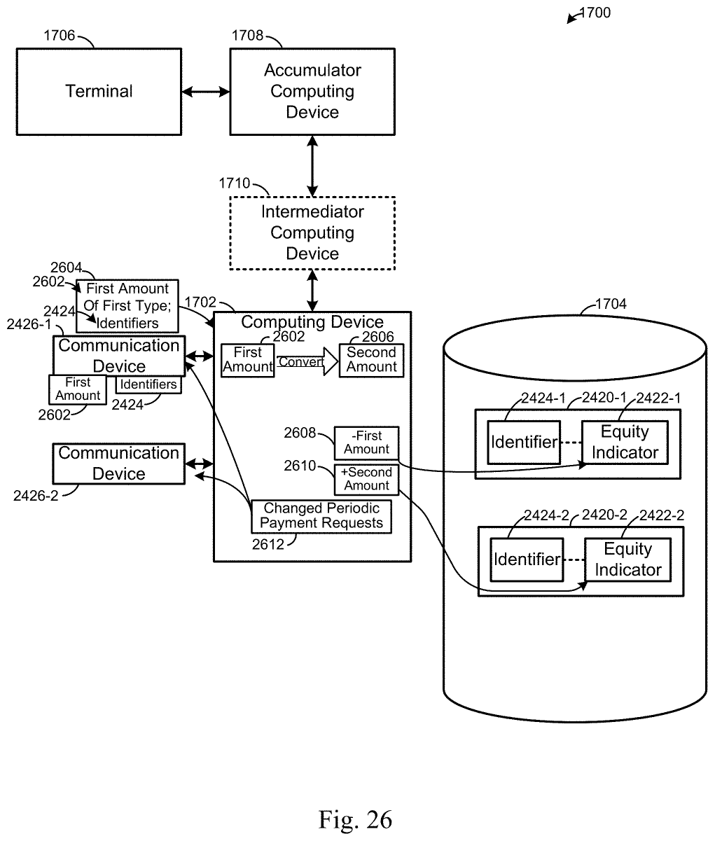

Attention is next directed to FIG. 26 which depicts an example of aspects of the method 2200. FIG. 26 is substantially similar to FIG. 24, with like components having like numbers. While components of the computing device 1702 are not depicted, they are nonetheless understood to be present.

Starting at the first communication device 2426-1, a first fungible amount 2602 of a first type is received (e.g. via an input device), along with the identifiers 2424. The further communication device 1728 transmits an indicator 2604 (e.g. in the form of a message) to the computing device 1702, the indicator 2604 including the first fungible amount 2602 and the identifiers 2424, the indicator 2604 may further indicate that the first fungible amount 2602 is to be used to pay for a good or service provided by the second equity owner associated with the second equity indicator 2422-2, using the first equity indicator 2422-1. For example, the identifiers 2424 may be provided in a given order, and/or as given input to an API at the computing device 1702, which indicates such.

The computing device 1702 receives (e.g. at the block 2502 of the method 2500), the indicator 2604, and identifies (e.g. at the block 2504 of the method 2500) the equity indicators 2422 from the identifiers 2424. Such an identification of the equity indicators 2422 may occur via a database lookup, and the like, at the memory 1704.

The computing device 1702 further converts (e.g. at the block 2506 of the method 2500) the first fungible amount 2602 of the first type to a second fungible amount 2606 of a second type. The computing device 1702 debits and/or reduces the first equity indicator 2422-1 by a first amount 2608 related to the first fungible amount 2602 (e.g. as indicated by the first amount 2608 depicted with a negative (“−”) sign in FIG. 26), and credits and/or increases the second equity indicator 2422-2 by a second amount 2610 related to the second fungible amount 2606 e.g. as indicated by the second amount 2610 depicted with a positive (“+”) sign in FIG. 26), causing (e.g. at the block 2508 of the method 2500) the equity indicators 2122 to change accordingly. The computing device 1702 changes (e.g. at the block 2510 of the method 2500) periodic payment requests 2612 to indicate the changes to the equity indicators 2122. As depicted, the periodic payment requests 2612 are provided to respective communication devices 2126.

In other examples, the first fungible amount 2602 (and/or a portion thereof) may be provided in the form of points, and the example of FIG. 26 may be modified such that the further communication device 1728, and/or the computing device 1702, communicates with one or more associated suitable points accumulator computing devices and/or one or more associated suitable points intermediator computing device (e.g., which may include, but not limited to, the computing devices 1708, 1710) to determine a value for the points to convert the first fungible amount 2602 (and/or the portion thereof) to the second fungible amount 2606, with associated debiting of a points account(s) occurring accordingly.

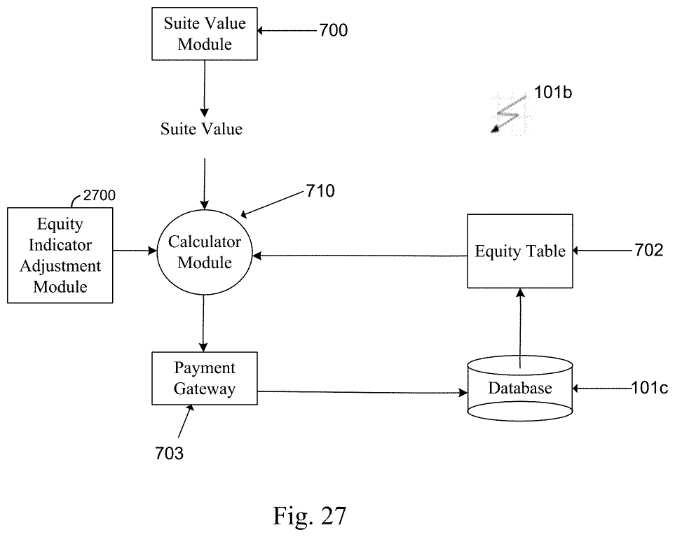

Attention is next directed to FIG. 27 which depicts the COE 101b depicted in FIG. 7 to include an equity indicator adjustment module 2700 which may be used to implement the various methods 1800, 200, 2500 described herein to adjust equity indicators described herein. In particular, the equity indicator adjustment module 2700 may interact with at least the calculator module 700 as described herein. As such, in these examples, the computing device 1702 may be understood to be implementing the COE 101b, and/or the computing device 1702 may comprise a component of the COE 101b.

While not described in detail, it is understood that the system 1700 may be further adapted to convert fungible amounts from the equity indicators into points. For example, via operation of applications of the communication devices described herein with respect to any of FIG. 17, FIG. 19, FIG. 20, FIG. 23, FIG. 24, and FIG. 26, an a fungible amount indicative of property value may be received at the computing device 1702, along with an indication of a particular property, and the like, which causes the computing device 1702 to communicate with one or more of the computing devices 1708, 1710 to “buy” and/or purchase points using the amount debited from a respective equity indicator using the fungible amount indicative of property value. As such, equity in a particular property may be used to purchase points, which may be redeemed in any suitable manner.

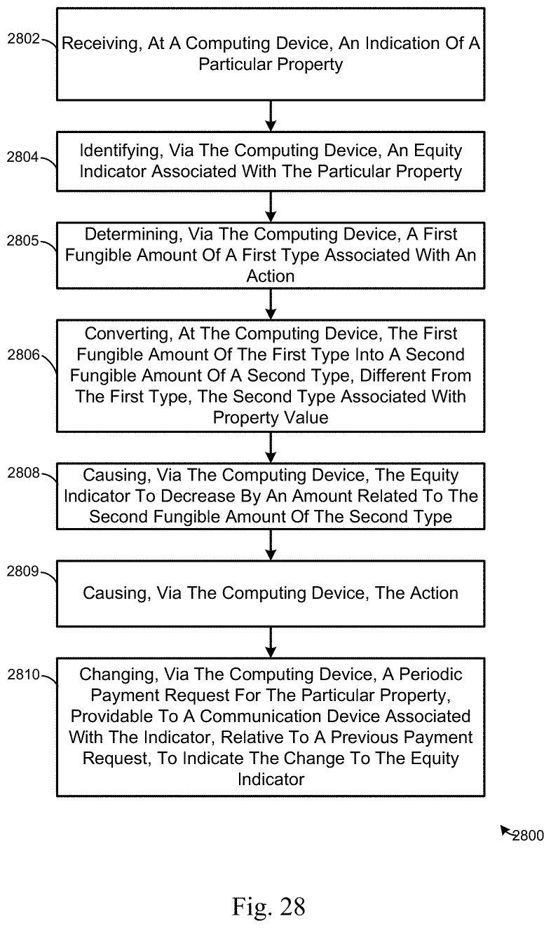

For example, attention is directed to FIG. 28, which depicts a flowchart representative of a method 2800 for changing a periodic payment request by reducing an equity indicator in association with causing an action. The operations of the method 2800 of FIG. 28 correspond to machine readable instructions that are executed by the computing device 1702, and specifically the controller 1712 of the computing device 1702. In the illustrated example, the instructions represented by the blocks of FIG. 28 are stored at the memory 1714 for example, as the application 1716 and/or a module of the application 1716 adapted for changing a periodic payment request by reducing an equity indicator in association with causing an action. The method 2800 of FIG. 28 is one way that the controller 1712 and/or the computing device 1702 and/or the system 100 may be configured. Furthermore, the following discussion of the method 2800 of FIG. 28 will lead to a further understanding of the system 100, and its various components.

The method 2800 of FIG. 28 need not be performed in the exact sequence as shown and likewise various blocks may be performed in parallel rather than in sequence. Accordingly, the elements of method 2800 are referred to herein as “blocks” rather than “steps.” The method 2800 of FIG. 28 may be implemented on variations of the system 100 of FIG. 1, as well.

It is further understood that the equity indicator adjustment module 2700 may be adapted to implement the functionality of the method 2800.

It is furthermore understood that the method 2800 is substantially similar to the method 1800, but adapted for changing a periodic payment request by reducing an equity indicator in association with causing an action, with like blocks having like numbers, but in a “2800” series rather than “1800” series.

At a block 2802, the computing device 1702 and/or the controller 1712 receives an indication of a particular property. For example, such an indication may comprise the identifier 1724 and/or any other suitable identifier.

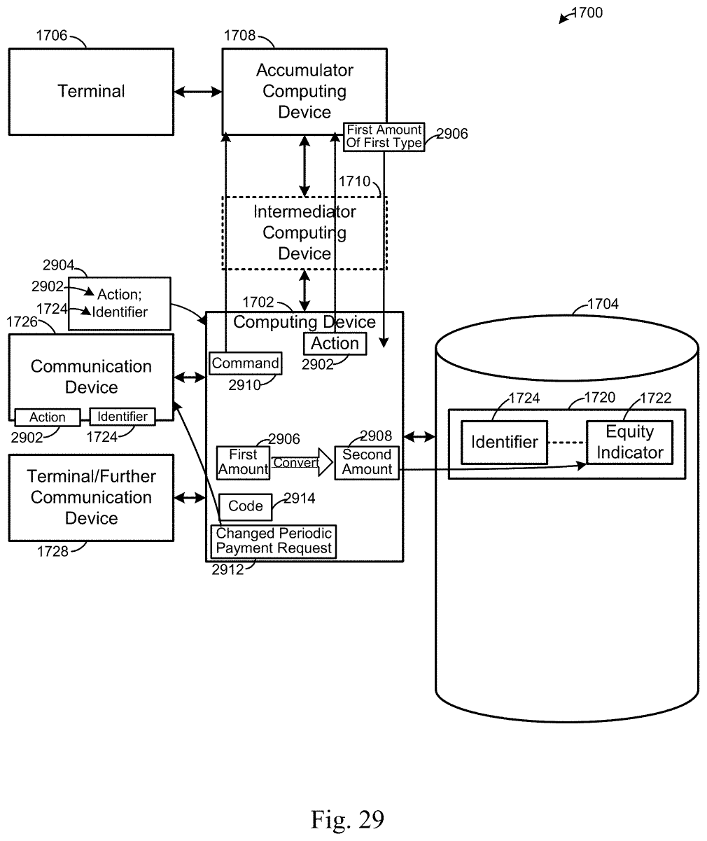

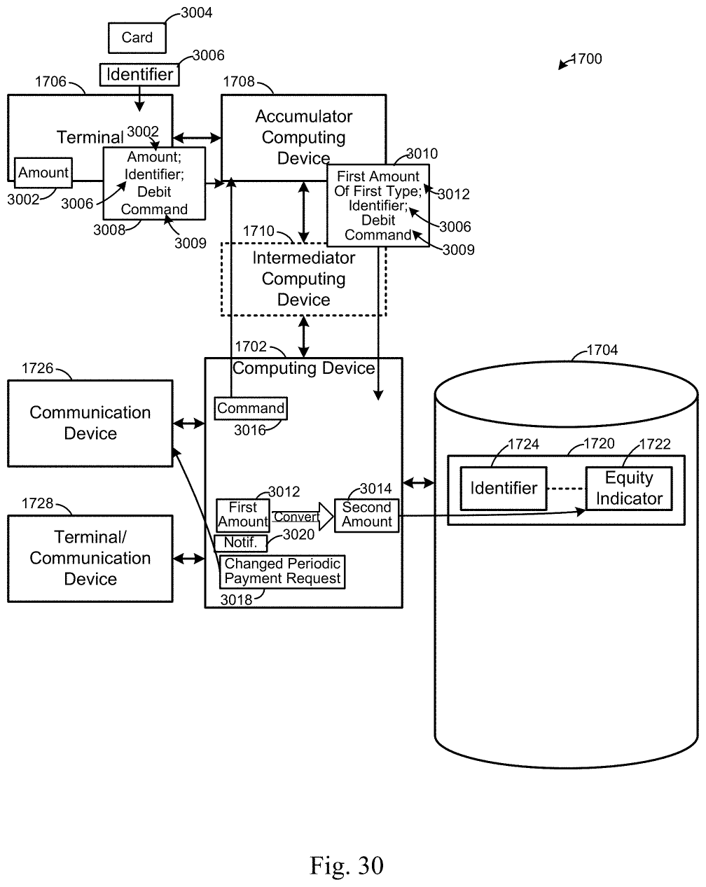

The indication of the particular property may be received from the communication device 1726. Alternatively, the indication of the particular property may be received from the terminal 1706. Various examples of receipt of the indication of the block 2802 are described below with respect to FIG. 29 and FIG. 30.

At a block 2804, the computing device 1702 and/or the controller 1712 identifies an equity indicator associated with the particular property. For example, the equity indicator 1722 may be identified using the identifier 1724, similar to as described elsewhere in the present specification.

At a block 2805, the computing device 1702 and/or the controller 1712 determines a first fungible amount of a first type associated with an action and/or an electronic action. For example, the indication received at the block 2802 may further indicate the and/or an electronic action, which may comprise causing one or more electronic devices to provide goods and/or services, and/or complete a transaction, and the like. In some examples, the computing device 1702 and/or the controller 1712 may determine the first fungible amount of the first type by communicating with one or more of the computing devices 1708, 1710 using the indication of the action to cause one or more of the computing devices 1708, 1710 to return the first fungible amount of the first type associated with the action.

However, in some examples, the first fungible amount of the first type may be received from the communication device 1726 or the terminal 1706; for example, the indication received at the block 2802 may further indicate the first fungible amount of the first type.

At a block 2806, the computing device 1702 and/or the controller 1712 converts the first fungible amount of the first type into a second fungible amount of a second type, different from the first type, the second type associated with property value, for example of the property associated with the equity indicator 1722 and/or the identifier 1724. Such a conversion may be similar to as described above with respect to the block 1806.

At a block 2808, the computing device 1702 and/or the controller 1712 causes the equity indicator 1722 to decrease by an amount related to the second fungible amount of the second type. Such a reduction may be similar to the change to the equity indictor 1722 described above with respect to the block 1808, but with the equity indictor 1722 decreasing rather than increasing.

At a block 2809, the computing device 1702 and/or the controller 1712 causes the action, for example via the communication interface 1718. For example, the computing device 1702 and/or the controller 1712 may communicate with one or more of the computing devices 1708, 1710 to transfer a respective amount related to the second fungible amount of the second type, along with a command to implement the action. For example, the first amount of the first type may comprise points, and the second fungible amount of the second type may comprise an amount of equity of the equity indicator 1722 that may be equivalent, in market value, to the points of the first amount of the first type. Transfer of the respective amount related to the second fungible amount of the second type may include transfer to an account of a digital wallet and/or a financial institution 104 similar to as described elsewhere in the present specification.

At a block 2810, the computing device 1702 and/or the controller 1712 changes a periodic payment request for the particular property, providable to the communication device 1726 associated with the indicator, relative to a previous payment request, to indicate the change to the equity indicator. The block 2810 is generally similar to the block 1810 of the method 1800.

Attention is next directed to FIG. 29 which depicts an example of aspects of the method 2800. FIG. 29 is substantially similar to FIG. 17, with like components having like numbers. While components of the computing device 1702 are not depicted, they are nonetheless understood to be present.

Starting at the communication device 1726, an indication 2902 of an action is received (e.g. via an input device), along with the identifier 1724. The indication 2902 of the action may be provided via an application (e.g. an “app”) at the communication device 1726. For example, while not depicted, the computing device 1702 may communicate with the one or more of the computing devices 1708, 1710 to determine available actions which may be provided in exchange for first fungible amounts of a first type, including, but not limited to, points, and the like. For example one or more of the computing devices 1708, 1710 may provide a menu and/or list of one or more available actions which may be provided in exchanged for first fungible amounts of a first type, and the menu and/or list may be provided to the communication device 1726 at an “app” thereof, for selection. Hence, in FIG. 29, it is understood that the indication 2902 of the action may be selected, at the communication device 1726 from a menu and/or of available actions.

As depicted, the identifier 1724 is also available to the communication device 1726 (e.g. via the “app”).

The communication device 1726 transmits an indication 2904 (e.g. in the form of a message) to the computing device 1702, the indication 2904 including the indication 2902 of the action and the identifier 1724.

The computing device 1702 receives (e.g. at the block 2802 of the method 2800), the indication 2904, and identifies (e.g. at the block 2804 of the method 2800) the equity indicator 1722 from the identifier 1724. Such an identification of the equity indicator 1722 may occur via a database lookup, and the like, at the memory 1704.

The computing device 1702 further determines (e.g. at the block 2805 of the method 2800) a first fungible amount 2906 of a first type associated with the action indicated by the indicator 2902, for example by transmitting the indicator 2902 to one or more of the computing devices 1708, 1710, which returns the first fungible amount 2906 of the first type. In one example, the first fungible amount 2906 of the first type may comprise a number of points for which the action may be provided in exchange therefor. However, as has already been described, the first fungible amount 2906 of the first type may be representative of the points converted into a currency-type amount, such as a value and/or a market-value of the points that is determined by one or more of the computing devices 1708, 1710 (e.g. the intermediator computing device 1710).

In further examples, the first fungible amount 2906 of the first type may have been determined by the computing device 1702 (e.g. received from one or more of the computing devices 1708, 1710) when the menu and/or list of actions was determined and provided to the communication device 1726. As such, in some of these examples, the first fungible amount 2906 of the first type may be received from the communication device 1726 with the indicator 2904. Hence, the block 2805 of the method 2800 may be combined with the block 2802 of the method 2800 and may include, but is not limited to, receiving the indication 2904 of the particular property and the first fungible amount 2906 of the first type from the communication device 1726.

The computing device 1702 further converts (e.g. at the block 2806 of the method 2800, similar to as described above with respect to the block 1806 of the method 1800) the first fungible amount 2906 of the first type to a second fungible amount 2908 of a second type related to property value. The computing device 1702 debits and/or reduces (e.g. at the block 2808 of the method 2800) the equity indicator 1722 by an amount (not depicted) related to the second fungible amount 2908. For example, the amount related to the second fungible amount 2908 may include a processing fee and/or service fee in addition to the second fungible amount 2908 of the second type. Hence, the block 2808 of the method 2800 may be similar to the block 1808 of the method 1800 but with respect to the equity indicator 1722 decreasing rather than increasing As such, the equity owner's pledge for a particular property is understood to decrease.

The computing device 1702 further causes the action indicated by the indicator 2902 to occur (e.g. at the block 2809 of the method 2800) by transmitting a command 2910 to one or more of the computing devices 1708, 1710. The command 2910 may comprise a command to implement the action indicated by the indicator 2902, as well as transfer of a respective amount related to the second fungible amount 2908 of the second type to exchange for the implementing the action. The respective amount related to the second fungible amount 2908 of the second type may be equivalent, and/or similar, to the first fungible amount 2906 of the first type.

The computing device 1702 further changes (e.g. at the block 2810 of the method 2800) a periodic payment request 2912 to indicate the decrease to the equity indicator 1722. As depicted, the periodic payment request 2912 is provided to the communication device 1726. As the equity indicator 1722 decreased, the monthly payment for the particular property may increase and such an increase is indicated in the periodic payment request 2912.

As depicted, a code 2914 may also be provided to the communication device 1726 to indicate the exchange of the respective amount related to the second fungible amount 2908 for the action. While not depicted, the code 2914 may be received from one or more of the computing devices 1708, 1710 and may comprise an electronic code, and/or an alphanumeric code, and/or a graphical code which may be used by another electronic device to confirm the exchange of the respective amount related to the second fungible amount 2908 for the action. The code 2914 may be presented at a display screen of the communication device 1726 to another communication device operated by a user delivering the goods and/or services as a confirmation.

Hence, the example of FIG. 29 may represent an exchange of equity in a particular property for points, which are exchanged for goods and/or services. For example, in response to receiving the command 2910, one or more of the computing devices 1708, 1710 may implement the action in exchange for the points which may include, but is not limited to, shipping goods to the particular property and/or providing a service to the particular property and/or the equity owner. As such, the command 2910 may include a street address of the particular property, which may be preconfigured at the computing device 1702. Furthermore, such shipping goods to the particular property and/or providing a service to the particular property and/or the equity owner (e.g. the action caused at the block 2809 of the method 2800) is understood to be implemented via electronic devices, which may include, but is not limited to, one or more of the computing devices 1708, 1710, and/or any other suitable electronic devices, such as communication devices operated by users delivering the goods and/or services.

Attention is next directed to FIG. 30 which depicts another example of aspects of the method 2800. FIG. 30 is substantially similar to FIG. 18 (and/or FIG. 19), with like components having like numbers. While components of the computing device 1702 are not depicted, they are nonetheless understood to be present.

Starting at the terminal 1706, a transaction of an amount 3002 (e.g. a currency-type amount) occurs, and a card 3004 is presented to the terminal 1706, which reads an identifier 3006 from the card 3004. The card 3004 may be similar to the card 1904. Alternatively the identifier 3006 may be provided by the communication device 1726. The card 3004 (and/or the communication device 1726) may be presented by the equity owner associated with the equity indicator 1722 and the identifier 3006 may comprise a loyalty points identifier, and the like.

In contrast to the example of FIG. 19, rather than complete a transaction via communication with the financial institutions 104 and/or a digital wallet (e.g. to debit an account of the equity owner an), the terminal 1706 may present an option to complete the transaction via points provided in exchange for a portion of the equity indicator 1722, as described hereafter.

In particular, presuming the option to complete the transaction via points provided in exchange for a portion of the equity indicator 1722 is selected at the terminal 1706, the terminal 1706 transmits a message 3008 to the accumulator computing device 1708, the message 3008 including the amount 3002, the identifier 3006, and a command 3009 (e.g. a debit command) to complete the transaction via points provided in exchange for a portion of the equity indicator 1722.

The accumulator computing device 1708 is understood to convert the amount 3002 to a first fungible amount 3012 of a first type (e.g. loyalty points), and transmits an indication 3010 (e.g. in the form of a message) to the computing device 1702 (e.g. via the intermediator computing device 1710) that includes the first fungible amount 3012 of the first type, the identifier 3006, and the command 3009.

The computing device 1702 receives (e.g. at the block 2802 of the method 2800), the indication 3010, and uses an association between the identifier 3006 and the identifier 1724 (not depicted) to identify the equity indicator 1722 (e.g. at the block 2804 of the method 2800, similar to as described above with respect to the block 1802 of the method 1800).

Furthermore, the block 2805 of the method 2800 may be implemented by receipt of the indication 3010 as, in these examples, the action of the block 2805 may comprise completing the transaction at the terminal 1706 (e.g. an electronic device) via points provided in exchange for a portion of the equity indicator 1722. As such, in these examples, the block 2805 of the method 2800 may include, but is not limited to, determining, from the indications 3010, the first fungible amount 3012 of the first type associated with an action indicated by the command 3009.

Hence, the first fungible amount 3012 of the first type may comprise a number of points for which the action indicated by the command 3009 may be provided (e.g. a number of points equivalent in value to the amount 3002). However, as has already been described, the first fungible amount 3012 of the first type may comprise the amount 3002; regardless, one or more of the computing devices 1708, 1710 determines a number of points equivalent in value to the amount 3002.

The computing device 1702 further converts (e.g. at the block 2806 of the method 2800, similar to as described above with respect to the block 1806 of the method 1800) the first fungible amount 3012 of the first type to a second fungible amount 3014 of a second type related to property value. The computing device 1702 debits and/or reduces the equity indicator 1722 by an amount (not depicted) related to the second fungible amount 3014 (e.g. at the block 2808 of the method 2800, similar to as described above with respect to the block 1808 of the method 1800 but with respect to decreasing rather than increasing).

The computing device 1702 further causes the action indicated by the command 3009 to occur (e.g. at the block 2809 of the method 2800) by transmitting a command 3016 to one or more of the computing devices 1708, 1710. The command 2910 may comprise a command to complete the transaction at the terminal 1706, as well as transfer of a respective amount related to the second fungible amount 2908 of the second type to exchange for the transaction. The respective amount related to the second fungible amount 2908 of the second type may be equivalent to the first fungible amount 2906 of the first type and/or the amount 3002. The action may further include exchanging points for the respective amount related to the second fungible amount 2908 of the second type at one or more of the computing devices 1708, 1710, which may be added to an account associated with the equity owner, and using such points to complete the transaction at the terminal 1706.

The computing device 1702 further changes (e.g. at the block 2810 of the method 2800) a periodic payment request 3018 to indicate the decrease to the equity indicator 1722. As depicted, the periodic payment request 3018 is provided to the communication device 1726. As the equity indicator 1722 decreased, the monthly payment for the particular property may increase and such an increase is indicated in the periodic payment request 3018.

As depicted, a notification 3020 may also be provided to the communication device 1726 to indicate the exchange of the respective amount related to the second fungible amount 2908 for the transaction.

Hence, the example of FIG. 30 may represent an exchange of equity in a particular property for points to complete a transaction at a terminal.

As should be apparent from this detailed description above, the operations and functions of computing devices, and the like, described herein are sufficiently complex as to require their implementation on a computer system, and cannot be performed, as a practical matter, in the human mind. Computing devices, and the like, such as set forth herein are understood as requiring and providing speed and accuracy and complexity management that are not obtainable by human mental steps, in addition to the inherently digital nature of such operations (e.g., a human mind cannot interface directly with a Random Access Memory, or other digital storage, cannot transmit or receive electronic messages and/or information, among other features and functions set forth herein).

In this disclosure, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this disclosure, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

What is claimed is:

1. A method comprising:
receiving, at a computing device, an indication of: a first fungible amount of a first type; and a particular property;
identifying, via the computing device, an equity indicator associated with the particular property;
converting, at the computing device, the first fungible amount of the first type into a second fungible amount of a second type, different from the first type, the second type associated with property value;
causing, via the computing device, the equity indicator to change by an amount related to the second fungible amount of the second type; and
changing, via the computing device, a periodic payment request for the particular property, providable to a communication device associated with the indicator, relative to a previous payment request, to indicate the change to the equity indicator.

2. The method of claim 1, further comprising:
providing, by the computing device, to the communication device associated with the indication, a message indicating the change to the equity indicator.

3. The method of claim 1, further comprising:
providing, by the computing device, to the communication device associated with the indication, the periodic payment request as changed.

4. The method of claim 1, wherein the first fungible amount of the first type has been generated based on activities not initially associated with the computing device.

5. The method of claim 1, wherein the first fungible amount of the first type is representative of points provided in exchange for purchase of one or more of goods and services external to the computing device.

6. The method of claim 5, wherein the first fungible amount of the first type is representative of the points converted into a currency-type amount.

7. The method of claim 5, further comprising: converting the first fungible amount from a points-type amount to a currency-type amount.

8. The method of claim 1, wherein the first fungible amount of the first type is received from one or more of a points accumulator computing device and a points intermediator computing device.

9. The method of claim 1, wherein the indication is received from one or more of a point-of-sale terminal and a further communication device.

10. The method of claim 1, wherein the indication is further of a plurality of particular properties, including the particular property, the method further comprising:
dividing the second fungible amount of the second type into a plurality of portions respectively associated with the plurality of particular properties; and
causing, via the computing device, changes to a plurality of equity indicators by respective amounts based on associated portions of the second fungible amount of the second type, the plurality of equity indicators respectively associated with the plurality of particular properties; and
changing respective periodic payment request for the plurality of particular properties, relative to respective previous payment requests, to indicate respective changes to plurality of equity indicators.

11. A device comprising:
a communication interface; and
a controller configured to:
receive, via the communication interface, an indication of: a first fungible amount of a first type; and a particular property;
identify an equity indicator associated with the particular property;
convert the first fungible amount of the first type into a second fungible amount of a second type, different from the first type, the second type associated with property value;
cause the equity indicator to change by an amount related to the second fungible amount of the second type; and
change a periodic payment request for the particular property, providable to a communication device associated with the indicator, relative to a previous payment request, to indicate the change to the equity indicator.

12. The device of claim 11, wherein the controller is further configured to:
provide, via the communication interface, to the communication device associated with the indication, a message indicating the change to the equity indicator.

13. The device of claim 11, wherein the controller is further configured to:
provide, via the communication interface, to the communication device associated with the indication, the periodic payment request as changed.

14. The device of claim 11, wherein the first fungible amount of the first type has been generated based on activities not initially associated with the computing device.

15. The device of claim 11, wherein the first fungible amount of the first type is representative of points provided in exchange for purchase of one or more of goods and services external to the computing device.

16. The device of claim 11, wherein the first fungible amount of the first type is received from one or more of a points accumulator computing device and a points intermediator computing device.

17. The device of claim 11, wherein the indication is received from one or more of a point-of-sale terminal and a further communication device.

18. The device of claim 11, wherein the indication is further of a plurality of particular properties, including the particular property, and the controller is further configured to:
divide the second fungible amount of the second type into a plurality of portions respectively associated with the plurality of particular properties; and
cause changes to a plurality of equity indicators by respective amounts based on associated portions of the second fungible amount of the second type, the plurality of equity indicators respectively associated with the plurality of particular properties; and
change respective periodic payment request for the plurality of particular properties, relative to respective previous payment requests, to indicate respective changes to plurality of equity indicators.

19. A method comprising:
receiving, at a computing device, an indication of: a first particular property; a second particular property, and a first fungible amount of a first type associated with the first particular property;
identifying, via the computing device, a first equity indicator associated with the first particular property and a second equity indicator associated with the second particular property;
converting, at the computing device, the first fungible amount of the first type into a second fungible amount of a second type, different from the first type, the second type associated with property value;
causing, via the computing device, the first equity indicator to reduce by a first amount associated with the second fungible amount and the second equity indicator to increase by a second amount associated with the second fungible amount; and
changing, via the computing device, respective periodic payment requests for the first particular property and the second particular property, providable to respective communication devices associated with the first particular property and the second particular property, relative to respective previous payment requests, to indicate changes to the first equity indicator and the second equity indicator.

20. A method comprising:
receiving, at a computing device, an indication of a particular property;
identifying, via the computing device, an equity indicator associated with the particular property;
determining, via the computing device, a first fungible amount of a first type associated with an action;
converting, at the computing device, the first fungible amount of the first type into a second fungible amount of a second type, different from the first type, the second type associated with property value;
causing, via the computing device, the equity indicator to decrease by an amount related to the second fungible amount of the second type;
causing, via the computing device, the action; and
changing, via the computing device, a periodic payment request for the particular property, providable to a communication device associated with the indicator, relative to a previous payment request, to indicate the change to the equity indicator.
